(19) United States
(12) Patent Application Publication
(10) Pub. No.: US 2026/0277558 A1
(43) Pub. Date: Sep. 17, 2026

(54) INFORMATION PROCESSING APPARATUS, APPLICATION CREATION METHOD, AND APPLICATION CREATION SYSTEM

(71) Applicants: Kazuma Okamura, TOKYO (JP); Yuki Hori, AICHI (JP); Seiichi Kondo, Tokyo (JP)

(72) Inventors: Kazuma Okamura, TOKYO (JP); Yuki Hori, AICHI (JP); Seiichi Kondo, Tokyo (JP)

(73) Assignee: Ricoh Company, Ltd., Tokyo (JP)

(21) Appl. No.: 19/557,657

(22) Filed: Mar. 5, 2026

(30) Foreign Application Priority Data
Mar. 17, 2025 (JP) 2025-042676
Jan. 8, 2026 (JP) 2026-001854

(51) Int. Cl. G06F 8/34; G06F 8/33; H04L 51/02

(52) U.S. Cl. CPC G06F 8/34; G06F 8/33; H04L 51/02

(57) ABSTRACT

An information processing apparatus communicably connected with a terminal apparatus and a generative artificial intelligence (AI) system via a network, including circuitry that displays an application creation screen that receives a user operation to arrange a plurality of components for an application to be created; displays a chat screen for receiving the assistance by the AI in response to reception of an operation on the button in the application creation screen; receives a chat message input on the chat screen; transmits, to the generative AI system, the received chat message and an instruction to generate parameters related to creation of the application; receives a request generated by the generative AI system based on the instruction, including the parameters; creates the application based on the received parameters; and displays an updated application creation screen including the plurality of components of the created application.

### CROSS-REFERENCE TO RELATED APPLICATIONS

This patent application is based on and claims priority pursuant to 35 U.S.C. § 119(a) to Japanese Patent Application Nos. 2025-042676, filed on Mar. 17, 2025, and 2026-001854, filed on Jan. 8, 2026, in the Japan Patent Office, the entire disclosure of which is hereby incorporated by reference herein.

### BACKGROUND

### Technical Field

The present disclosure relates to an information processing apparatus, an application creation method, and an application creation system.

### Related Art

There is a technique that assists programming by eliminating or reducing the need to manually enter program code. For example, artificial intelligence (AI) can be used to automatically generate program code.

In order to generate a program such as an application by using an AI system, it has been necessary to develop, maintain, or operate the AI system separately from the application.

### SUMMARY

The present disclosure described herein provides an information processing apparatus communicably connected with a terminal apparatus and a generative artificial intelligence (AI) system via a network, including circuitry that: causes the terminal apparatus to display an application creation screen that receives a user operation to arrange a plurality of components for an application to be created, the application creation screen including a button for receiving a request for assistance by the AI in creating the application; causes the terminal apparatus to display a chat screen for receiving the assistance by the AI in response to reception of an operation on the button in the application creation screen; receives, from the terminal apparatus, a chat message input on the chat screen; transmits, to the generative AI system, the received chat message and an instruction to generate parameters related to creation of the application based on the received chat message; receives a request generated by the generative AI system based on the instruction, the request including the parameters related to creation of the application; creates the application based on the received parameters; and causes the terminal apparatus to display an updated application creation screen including the plurality of components of the created application.

The present disclosure described herein provides an application creation method including displaying, on a display, an application creation screen that receives a user operation to arrange a plurality of components for an application to be created, the application creation screen including a button for receiving a request for assistance by an artificial intelligence (AI) in creating the application; displaying, on the display, a chat screen for receiving the assistance by the AI in response to reception of an operation on the button in the application creation screen; receiving a chat message input on the chat screen; transmitting, to a generative AI system, the received chat message and an instruction to generate parameters related to creation of the application based on the received chat message; receiving a request generated by the generative AI system based on the instruction, the request including the parameters related to creation of the application; creating the application based on the received parameters; and displaying, on the display, an updated application creation screen including the plurality of components of the created application.

The present disclosure described herein provides an application creation system including a terminal apparatus comprising terminal circuitry, and an information processing apparatus communicably connected with the terminal apparatus via a network, including apparatus circuitry. The terminal circuitry acquires, from the information processing apparatus, web content data for displaying an application creation screen that receives a user operation to arrange a plurality of components for an application to be created, the application creation screen including a button for receiving a request for assistance by an artificial intelligence (AI) in creating the application; displays, on a display, the application creation screen based on the acquired web content data; transmits, to the generative AI system via the network, a chat message input on a chat screen for receiving the assistance by the AI, and an instruction to generate parameters related to creation of the application based on the received chat message, the chat screen being displayed on the display in response to reception of an operation on the button in the application creation screen; receives a request generated by the generative AI system based on the instruction, the request including the parameters related to creation of the application; transmits the received parameters to the information processing apparatus; receives update information for displaying, on the application creation screen, a plurality of components of the created application having been created by the information processing apparatus based on the parameters; and displays the plurality of components of the created application on the application creation screen based on the received update information. The apparatus circuitry transmits the web content to the terminal apparatus; creates the application based on the parameters transmitted from the terminal apparatus; and transmits, to the terminal apparatus, the update information for causing the application creation screen to display the plurality of components of the created application.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a configuration of an application creation system according to a first embodiment;

FIG. 2 is a diagram illustrating an example of a hardware configuration of an information processing system, a user terminal, and a developer terminal, according to one or more embodiments;

FIG. 3 is a diagram illustrating functions performed by each apparatus included in the application creation system according to the first embodiment;

FIG. 4 is an example of a component management table;

FIG. 5 is an example of an application management table;

FIG. 6 is a sequence diagram illustrating an example operation performed by the application creation system according to the first embodiment;

FIG. 7 is a diagram illustrating a first example of a screen displayed on the user terminal according to the first embodiment;

FIG. 8 is a diagram illustrating a second example of a screen displayed on the user terminal according to the first embodiment;

FIG. 9 is a diagram illustrating a third example of a screen displayed on the user terminal according to the first embodiment;

FIG. 10 is a diagram illustrating an example prompt;

FIG. 11 is a diagram illustrating an example of a response message transmitted from the generative AI system in response to the prompt;

FIG. 12 is a diagram illustrating a fourth example of a screen displayed on the user terminal according to the first embodiment;

FIG. 13 is a diagram illustrating a fifth example of a screen displayed on the user terminal according to the first embodiment;

FIG. 14 is a sequence diagram illustrating an example operation performed by the application creation system according to a first modification of the first embodiment;

FIG. 15 is a diagram illustrating an example of a screen displayed on the user terminal according to the first modification of the first embodiment;

FIG. 16 is a diagram illustrating a first example of a screen displayed on the user terminal according to the second modification of the first embodiment;

FIG. 17 is a flowchart of processing performed by the information processing system according to the second modification of the first embodiment;

FIG. 18 is a diagram illustrating a second example of a screen displayed on the user terminal according to the second modification of the first embodiment;

FIG. 19 is a diagram illustrating a third example of a screen displayed on the user terminal according to the second modification of the first embodiment;

FIG. 20 is a diagram illustrating an example of a screen displayed on the user terminal according to the third modification of the first embodiment;

FIG. 21 is a flowchart of processing performed by the information processing system according to the third modification of the first embodiment;

FIG. 22 is a diagram illustrating functions performed by each apparatus included in the application creation system according to a second embodiment; and

FIG. 23 is a sequence diagram illustrating an example operation performed by the application creation system according to the second embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

### First Embodiment

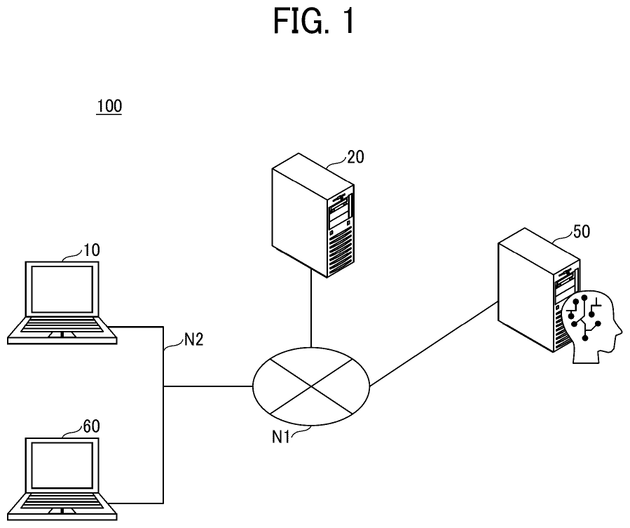

An application creation system according to a first embodiment will be described below with reference to the drawings. FIG. 1 is a diagram illustrating a configuration of an application creation system 100 according to the first embodiment.

The application creation system 100 includes an information processing system (server) 20, a user terminal 10, and a developer terminal 60.

In the application creation system 100, the information processing system 20 and the user terminal 10, and the information processing system 20 and the developer terminal 60, are communicably connected to each other via networks N1 and N2. The information processing system 20 communicates with a generative AI system 50 via the network N1. The user terminal 10 and the developer terminal 60 are communicatively connected to the generative AI system 50 via the networks N1 and N2.

The network N1 is a network for a wide area, such as Internet or a wide area network (WAN). The network N2 may be a local area network (LAN), Wi-Fi®, a wide area Ethernet®, or a mobile phone network of 4G, 5G, or 6G.

The user terminal 10 is, for example, a terminal apparatus used by a user who uses a service provided by the information processing system 20, such as a personal computer (PC), a smartphone, or a tablet terminal. The developer terminal 60 is a terminal apparatus used by, for example, a developer of the information processing system 20.

The user terminal 10 and the developer terminal 60, which are provided at facilities such as offices or houses, are connected to the network N2. The user terminal 10 and the developer terminal 60 do not always need to be connected to the network N2. The user terminal 10 and the developer terminal 60 may be connected when the information processing system 20 or the generative AI system 50 is used. A web browser or a native application operates on the user terminal 10 or the developer terminal 60. The user terminal 10 or the developer terminal 60 can use various services provided by the information processing system 20 or the generative AI system 50.

When the user inputs information on an application, the user terminal 10 transmits the input content to the information processing system 20. The information on the application includes, for example, an intended use of the application, and a type of data to be managed in the application.

The application created in the present embodiment is, for example, a database web application that manages data in the form of a table. The user may customize the application, for example, by freely setting the fields of the application to store, read, or process data related to the user's business. In the description below, the term “application” may be referred to as an “app”.

The developer terminal 60 generates setting data used to create an application in response to an operation by the developer. The setting data is stored in the information processing system 20. The setting data will be described in detail below.

The generative AI system 50 provides a service for the user to chat with the AI. The generative AI system 50 may be based on the large language model (LLM). The large language model is a model designed for the natural language processing, which is trained using a large amount of text data.

The generative AI system 50 is input with a vast amount of text, and obtains knowledge from the input text, for example, by deep learning or reinforcement learning. The generative AI system 50 uses the obtained knowledge to output a response message to data based on the chat message.

The generative AI system 50 includes an interface that receives data input by the user, such as a chat message or an electronic file. The data such as the chat message or the file received by this interface is referred to as a prompt. As the prompt, a chat message of an instruction or question is input. The chat message may be a part of the conversation or words in the natural language spoken by the human. One example of the electronic file is an image. The generative AI system 50 that generates a sentence with respect to the chat message may be referred to as the generative AI.

Example features of the generative AI system 50 include the capabilities to carry on a chat in a natural flow, expand ideas and make suggestions in a field in which the user lacks knowledge, and output accurate program code.

The generative AI system 50 may be based on LLM such as GPT-3®, GPT-4®, Transformer®, or BERT®. It is assumed that the application creation system 100 uses the ChatGPT based on GPT-3 or GPT-4 as an example. Alternatively the application creation system 100 may use any other LLM.

The generative AI system 50 and the information processing system 20 may be provided by the same provider or different providers.

When the information processing system 20 receives an operation to start creation of an application from the user terminal 10, the information processing system 20 causes the user terminal 10 to display a chat screen to assist the user in creating application.

When a chat message related to the creation of an application is input on the chat screen displayed on the user terminal 10, the information processing system 20 transmits an instruction to generate parameters related to the creation of the application based on the chat message to the generative AI system 50. In response to receiving a request including the parameters related to the creation of the application from the generative AI system 50, the information processing system 20 creates the application based on the received parameters and provides the application to the user terminal 10.

As described above, in the present embodiment, the user can create the application by inputting a chat message related to the creation of the application on the chat screen displayed on the user terminal 10. With this configuration, even the user who does not have knowledge about the program code can easily create the application.

In FIG. 1, the generative AI system 50 and the information processing system 20 are separately provided, but the present disclosure is not limited to this configuration. For example, the generative AI system 50 and the information processing system 20 may be combined into one system.

The information processing system 20 may be implemented by cloud computing or may be implemented by a single information processing apparatus. The “cloud computing” refers to internet-based computing where resources on a network are used or accessed without identifying specific hardware resources. The information processing system 20 may reside on the Internet or may reside on-premises.

The functions of the information processing system 20 may be distributed to a plurality of information processing apparatuses 20. The plurality of information processing systems 20 having the same functions are provided, and the number of information processing systems 20 that execute processes may be changed in accordance with the processing load.

The user terminal 10 is, for example, a terminal apparatus used by a user who receives a service provided by the information processing system 20, such as a PC, a smartphone, or a tablet terminal.

The user terminal 10 or the developer terminal 60 may be implemented by an information processing apparatus. Examples of the information processing apparatuses include an output apparatus such as an electronic whiteboard or a digital signage, head-up display (HUD), an industrial machine, an imaging apparatus such as a digital camera, a sound collecting apparatus, medical device, network home appliance, a mobile phone, a smartphone, a tablet terminal, a game machine, a personal digital assistant (PDA), and a wearable PC.

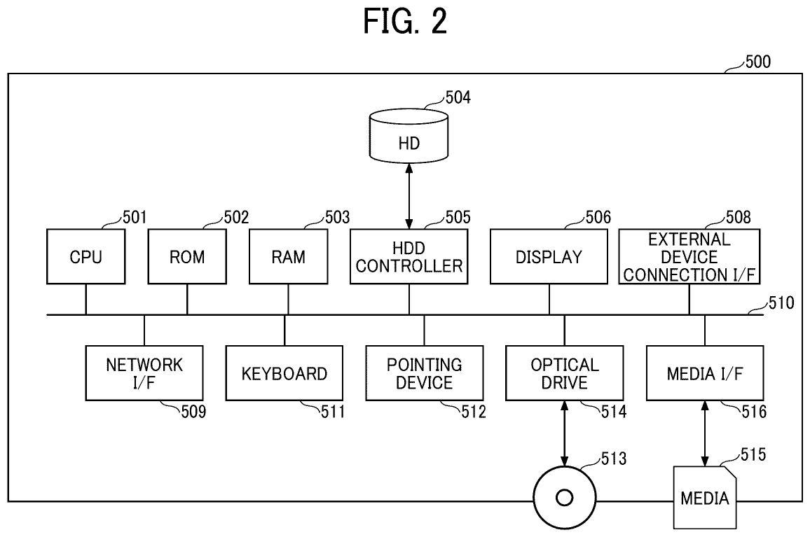

A hardware configuration of the application creation system 100 is described below with reference to FIG. 2.

FIG. 2 is a diagram illustrating an example of a hardware configuration of each of the information processing system 20, the user terminal 10, and the developer terminal 60. As illustrated in FIG. 2, the information processing system 20, the user terminal 10, and the developer terminal 60 are each implemented by a computer 500. The computer 500 includes a central processing unit (CPU) 501, a read-only memory (ROM) 502, a random access memory (RAM) 503, a hard disk (HD) 504, a hard disk drive (HDD) controller 505, a display 506, an external device connection interface (I/F) 508, a network I/F 509, a bus line 510, a keyboard 511, a pointing device 512, an optical drive 514, and a media I/F 516.

The CPU 501 controls overall operation of the computer 500. The ROM 502 stores a program for executing the CPU 501, such as an initial program loader (IPL). The RAM 503 is used as a work area for the CPU 501. The HD 504 stores various data such as software programs. The HDD controller 505 controls reading and writing of various data from and to the HD 504 under control of the CPU 501. The display 506 displays various information such as a cursor, a menu, a window, text, or an image. The external device connection I/F 508 is an interface circuit that connects the computer 500 to various external devices. Examples of the external devices include, but are not limited to, a universal serial bus (USB) memory and a printer.

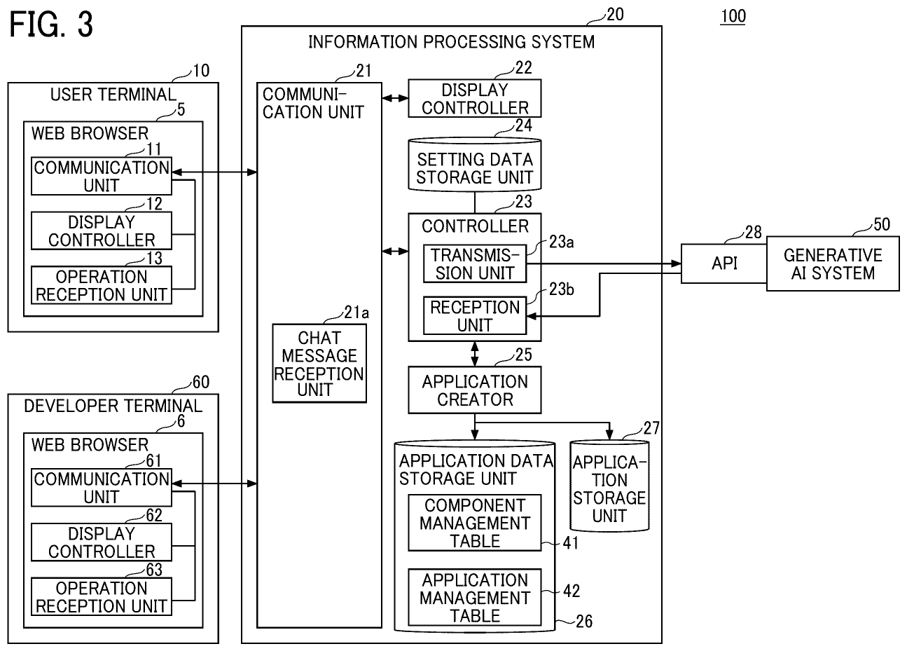

The network I/F 509 is an interface circuit for performing data transmission using the network N2. The bus line 510 is, for example, an address bus or a data bus for electrically connecting the components illustrated in FIG. 3, such as the CPU 501, with each other.

The keyboard 511 is an example of an input device that includes a plurality of keys for inputting characters, numerical values, or various instructions. The pointing device 512 is an example of an input device used to select or execute a specific instruction, select a target for processing, or move a cursor. The optical drive 514 controls reading or writing of various kinds of data from or to an optical disc 513 such as a digital versatile disc-rewritable (DVD-RW), which is an example of a removable recording medium. The removable recording medium is not limited to the DVD-RW and may be, for example, a digital versatile disc recordable (DVD-R). The media I/F 516 controls reading and writing (storing) of data from and to recording media 515 such as a flash memory.

The functions of the information processing system 20, the user terminal 10, and the developer terminal 60 included in the application creation system 100 are described with reference to FIG. 3. FIG. 3 is a diagram illustrating functions performed by each apparatus included in the application creation system 100 according to the first embodiment.

The functions of the information processing system 20 are described. The information processing system 20 includes a communication unit 21, a display controller 22, a controller 23, a setting data storage unit 24, an application creator 25, an application data storage unit 26, and an application storage unit 27. These functional units of the information processing system 20 are functions or means that are implemented by the CPU 501 illustrated in FIG. 2 executing instructions included in one or more programs installed in the information processing system 20.

The setting data storage unit 24, the application data storage unit 26, and the application storage unit 27 are implemented by a memory such as the HD 504 or the RAM 503 illustrated in FIG. 2. The setting data storage unit 24 and the application data storage unit 26 may not be included in the information processing system 20. For example, the setting data storage unit 24 or the application data storage unit 26 may be provided on the network as long as they are accessible by the information processing system 20.

The communication unit 21 transmits and receives various kinds of information to and from the user terminal 10. The communication unit 21 transmits, to the user terminal 10, screen information of an application creation screen for creating an application and screen information of a chat screen for inputting a chat message related to the creation of the application.

The communication unit 21 includes a chat message reception unit 21a, which receives, from the user terminal 10, information including the chat message input by the user on the chat screen. The communication unit 21 further transmits and receives various types of information to and from the developer terminal 60. The communication unit 21 transmits screen information of an input screen for allowing the developer to input setting data to the developer terminal 60. The communication unit 21 receives the setting data input by the developer from the developer terminal 60, and stores the setting data in the setting data storage unit 24. The communication unit 21 transmits a response message, which is received by the controller 23 from the generative AI system 50, to the user terminal 10.

The display controller 22 generates screen information of a screen (web page), which is displayed by the user terminal 10 or the developer terminal 60.

More specifically, the display controller 22 generates the screen information of the application creation screen for creating the application to be displayed on the user terminal 10. The display controller 22 transmits the screen information of the application creation screen to the user terminal 10 via the communication unit 21, and causes the user terminal 10 to display the application creation screen. The screen information of the application creation screen is an example of web content data described in HyperText Markup Language (HTML) and JavaScript®.

The web content data is provided as a part of the web application. The screen information, which is the Web content data, is a program described in, for example, HTML, JavaScript®, JSON, Extensible Markup Language (XML), or Cascading Style Sheet (CSS). The structure of a web page is specified by HTML, the operation of the web page is defined by JavaScript®, and the style of the web page is specified by CSS.

The application creation screen includes a plurality of components. The application is created by arranging the plurality of components on the application creation screen by a user operation.

The application creation screen includes an operation button for receiving a request for AI assistance in creating the application. When the operation button for AI assistance is selected, a chat window is displayed together with the application creation screen. The chat window is an example of a chat screen for receiving the assistance from the generative AI system 50 in creating the application. The application creation screen and the chat window will be described in detail below. The display controller 22 generates screen information of various screens for displaying the created application on the user terminal 10.

The controller 23 calls an application programming interface (API) 28 to transmit a prompt to the generative AI system 50. The prompt includes information defining the chat message or a function input in the chat window displayed on the user terminal 10.

The controller 23 includes a transmission unit 23a and a reception unit 23b. The transmission unit 23a is an example of a first transmission unit, and transmits a prompt generated by the controller 23 to the generative AI system 50.

The prompt generated by the controller 23 is an instruction to generate the parameters related to the creation of the application based on the chat message received by the chat message reception unit 21a, and includes the chat message received by the chat message reception unit 21a. The prompt generated by the controller 23 may include information on the application, such as the name of the application, the goal in creating the application, the item name (field name) of data items to be managed by the application, or the arrangement of the data items to be managed by the application.

The API 28 is one or more APIs published by the generative AI system 50. The reception unit 23a is an example of a first reception unit. As a result of invoking the API 28, the reception unit 23a of the controller 23 receives a response to the prompt from the generative AI system 50. The response received by the reception unit 23b is a request generated by the generative AI system 50 based on the prompt (instruction). Specifically, the response received by the reception unit 23b is a request including the parameters related to the creation of the application. The response received by the reception unit 23b includes a function call request to the information processing system 20, or a uniform resource locator (URL) of the created or developed application.

The setting data storage unit 24 stores the setting data. The setting data will be described below.

The setting data includes information for the generative AI system 50 to create the application, and includes a function name for identifying the function that defines the process of creating the application.

Specifically, the function defining the creation process is a function that enables the generative AI system 50 to request the information processing system 20 to associate the fields managed by the application with the components.

In the present embodiment, the developer stores the setting data in the setting data storage unit 24 before the user starts creating the application. Accordingly, the user does not have to include the parameters of the application in the chat message.

The information processing system 20 generates the prompt to be transmitted to the generative AI system 50, using the setting data. As described above, the developer stores the setting data in the information processing system 20. With this configuration, the user is able to create the application with a simple operation even if the user does not have specialized knowledge about the application.

The setting data is not necessarily used in all cases, and the setting data may not be used depending on the application.

The application creator 25 creates the application based on the parameters included in the response message received from the generative AI system 50, and operates with execution of the function previously defined.

The application creator 25 creates the application with execution of the function called by the function call included in the response message, which is received by the controller 23 from the generative AI system 50. The application creator 25 outputs the URL of the application when creation of the application is successful, and outputs an error message when creation of the application fails.

The application creator 25 may generate a macro that operates on spreadsheet software, or may set a field in database software.

The application data storage unit 26 includes a component management table 41 and an application management table 42. The component management table 41 stores component information related to the components displayed on the application creation screen.

The components displayed on the application creation screen will be described below. The components included in the application creation screen are input fields to which data managed by the application is input. More specifically, the components included in the application creation screen are the input fields, which are associated with the item names of data managed by the application and to which the values of the data items managed by the application are input.

In the following description, the data item managed by the application may be referred to as a field managed by the application. In other words, each component is associated with the corresponding field managed by the application, and the field name of the field managed by the application is information for identifying the component.

In the present embodiment, the data type of the data to be input is preset for each component. Each field is associated with the component having a data type preset to the value of the field. Accordingly, the value of the field is automatically input in the preset data type.

The component information indicates a data type of each component.

The application management table 42 stores information used to manage the application created by the application creator 25. The details of each table will be described below.

The application storage unit 27 stores the one or more applications created by the application creator 25.

The functions of the user terminal 10 will be described below. The user terminal 10 includes a communication unit 11, a display controller 12, and an operation reception unit 13, each of which is implemented by a web browser 5. These functional units are functions or means, which are implemented by the CPU 501 illustrated in FIG. 2 executing instructions included in one or more programs installed on the user terminal 10.

For example, the communication unit 11, the display controller 12, and the operation reception unit 13 may be implemented by JavaScript® in the web browser 5. Alternatively, the communication unit 11, the display controller 12, and the operation reception unit 13 may be implemented by any script other than JavaScript®.

The communication unit 11 transmits and receives various types of information to and from the information processing system 20. The communication unit 11 receives screen information of the application creation screen from the information processing system 20. The communication unit 11 further receives screen information of a screen to be displayed by the created application from the information processing system 20. The communication unit 11 transmits, to the information processing system 20, the input content input on the chat screen or operation information indicating the operation performed on the user terminal 10. The communication unit 11 may directly communicate with the generative AI system 50.

The display controller 12 interprets the screen information of various screens and displays the screen information on the display 506. The operation reception unit 13 receives various user operations on various screens displayed on the display 506. The display is an example of a displaying unit of the user terminal 10.

The functions of the developer terminal 60 will be described below. The developer terminal 60 includes a communication unit 61, a display controller 62, and an operation reception unit 63, each of which is implemented by a web browser 6. These functional units are functions or means that are implemented by the CPU 501 illustrated in FIG. 2 executing instructions included in one or more programs installed in the developer terminal 60. For example, the communication unit 61, the display controller 62, and the operation reception unit 63 may be implemented by JavaScript® in web browser 6 or other script in web browser 6. When the developer terminal 60 executes the native application, these functional units may be implemented by the native application.

The communication unit 61 transmits and receives various types of information to and from the information processing system 20. The communication unit 61 receives, from the information processing system 20, screen information used for inputting the setting data. The communication unit 61 transmits the setting data or the operation information, which is received at the developer terminal 60, to the information processing system 20. The communication unit 21 may also communicate with the generative AI system 50.

The display controller 62 interprets the screen information of various screens and displays the screen information on the display 506.

The operation reception unit 63 receives various user operations performed on the various screens displayed on the display 506.

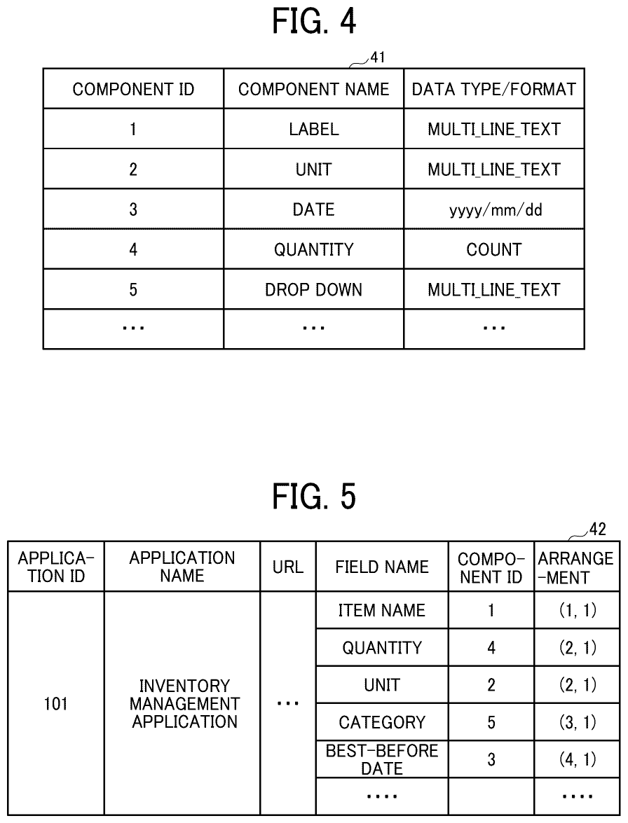

The tables included in the application data storage unit 26 will be described with reference to FIGS. 4 and 5.

FIG. 4 is an example of a component management table 41. The component management table 41 includes, as data items, a component ID, a component name, and a data type, which are associated with one another. The value of the item “component ID” is identification information for identifying a data type preset for the component. The value of the item “component name” indicates the name of the component. The value of the item “data type” indicates a data type corresponding to the component ID.

FIG. 4 illustrates that the data type input to the component “label” specified by the component ID “1” is “MULTI_LINE_TEXT”, and the data type input to the component “quantity” specified by the component ID “4” is “COUNT”.

The component information stored in the component management table 41 may be edited, for example, by an administrator of the information processing system 20. The editing includes addition and deletion.

FIG. 5 is an example of an application management table 42. The application management table 42 stores application management information used to manage the application created by the application creator 25.

The application management information includes, for example, an application ID, an application name, a URL, and a field name, a component ID, and an arrangement, as data items. The application ID and the other items are associated with each other.

The value of the item “application ID” is identification information for identifying the created application. The value of the item “application name” indicates the name of the created application. The value of the item “URL” indicates a location of the storage destination where the created application is stored. The application storage destination may be the application storage unit 27 of the information processing system 20 or may be a storage area of a storage device outside the information processing system 20 that can communicate with the information processing system 20. The value of the item “field name” indicates the name of a field managed by the created application. The value of the item “component ID” indicates the component ID for specifying the data type of the component associated with the field name. The value of the item “arrangement” indicates the position of the field, which is the position where the field is arranged, when the application is displayed.

FIG. 5 illustrates that the “inventory management application” specified by the application ID “101” includes, as the fields to be managed, an item name, a quantity, a unit, a category, and a best-before date. The image may be included as the field to be managed. The data type of the component, which is the input field to which the value of the field “item name” is input, is “MULTI_LINE_TEXT” specified by the component ID “1”. The data type of the component, which is the input field to which the value of the field “quantity” is input, is “COUNT” specified by the component ID “4”.

As described above, the field name managed by the application created by the application creator 25 is information that is associated with the component and identifies the component included in the application.

FIG. 5 illustrates that, when a screen for the inventory management application is displayed, the field “item name” is arranged at the first column of the first row, the field “quantity” is arranged at the second column of the first row, the field “quantity” is arranged at the first column of the second row, and the field “category” is arranged at the second column of the second row.

In the present embodiment, each time the application creator 25 creates the application, the application creator 25 stores, in the application management table 42, the application management information for the created application.

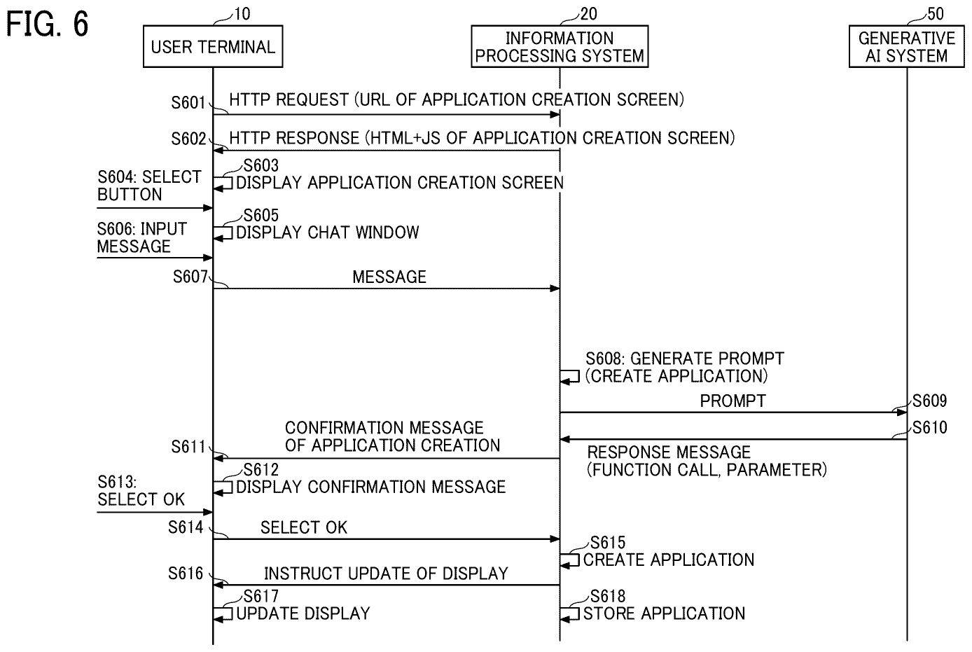

An example operation performed by the application creation system 100 is described below with reference to FIG. 6. FIG. 6 is a sequence diagram illustrating an example operation performed by the application creation system 100 according to the first embodiment.

In the application creation system 100, at step S601, the user terminal 10 requests the information processing system 20 to display an application creation screen via the communication unit 11. Specifically, the user terminal 10 transmits an HTTP request (request) specifying the URL of the application creation screen to the information processing system 20.

In response to the request from the user terminal 10, at step S602, the information processing system 20 causes the display controller 22 to generate screen information of an application creation screen for creating an application, and transmits the generated screen information to the user terminal 10. The application creation screen displayed on the user terminal 10 based on the screen information transmitted from the information process system 20 to the user terminal 10 at step S602 includes an operation button for requesting the assistance by the AI in creating the application.

More specifically, when the information processing system 20 receives the HTTP request (request) specifying the URL from the user terminal 10 via the communication unit 21, the information processing system 20 transmits an HTTP response including the screen information (the web content data including HTML and JavaScript®) of a screen specified by the URL.

When the communication unit 11 receives the screen information, at S603, the display controller 12 of the user terminal 10 displays the application creation screen for creating an application based on the received screen information. The application creation screen displayed on the user terminal 10 at step S603 includes the operation button for requesting the assistance by the AI in creating the application.

More specifically, when the user terminal 10 receives the HTTP request transmitted from the information processing system 20, the web browser 5 executes JavaScript® embedded in the screen information (HTML) included in the received HTTP request, and causes the display 506 to display the application creation screen for creating the application.

In the user terminal 10, when the operation reception unit 13 receives an operation of selecting the operation button for requesting the assistance by the AI in creating the application at step S604, the display 506 displays a chat window for chatting with the generative AI system 50 at step S605.

More specifically, the web browser 5 on the user terminal 10 executes JavaScript® embedded in the screen information of the application creation screen to display the chat window. The chat window is an example of the chat screen.

When the operation reception unit 13 receives an input of a chat message to the chat window at step S606, the user terminal 10 transmits the chat message to the information processing system 20 via the communication unit 11 at step S607. The user terminal 10 transmits the input chat message in the form of, for example, an HTTP request. The chat message being input is a chat message related to the creation of the application.

When the chat message reception unit 21a receives the chat message, the information processing system 20 causes the controller 23 to generate a prompt at step S608, and transmits the prompt to the generative AI system 50 at step S609.

The prompt being generated includes the chat message received from the user terminal 10 and an instruction to generate the parameters related to the creation of the application based on the chat message. More specifically, the prompt being generated includes a chat message related to the creation of the application and a function name for identifying a function that causes the application creator 25 to perform the specific function. Specifically, the transmission unit 23a of the controller 23 transmits the function name for identifying the function that causes the application creator 25 to perform the specific function to the generative AI system 50 at least once. The details of the generated prompt will be described below.

In FIG. 6, the information processing system 20 generates a prompt after receiving the chat message from the user terminal 10 at step S607, but the present embodiment is not limited to this example. For example, after the chat message is input to the user terminal 10 at step S606, the user terminal 10 may display a response message for prompting the user to input another chat message. The response message being displayed may be, for example, a response message previously embedded in the screen information of the application creation screen or a response message received from the generative AI system 50.

At step S610, in the information process system 20, the reception unit 23b of the controller 23 receives the response message from the generative AI system 50. The response message that is received is a request generated by the generative AI system 50, which includes the function name for identifying the function that causes the application creator 25 to perform the specific function. The response message that is received at the reception unit 23b is a request generated by the generative AI system 50 based on the prompt, which includes the parameters related to the creation of the application and the function name for identifying the function that causes the application creator 25 to perform the specific function.

In response to the response message, at step S611, the application creator 25 transmits a confirmation message for confirming the application to be created to the user terminal 10. The transmitted confirmation message includes the parameters included in the response message received from the generative AI system 50 at step S610. The parameters include information on the fields managed by the application.

At step S612, the user terminal 10 causes the display controller 12 to display the confirmation message in the chat window. When the operation reception unit 13 receives an operation of instructing creation of the application at step S613, the communication unit 11 of the user terminal 10 transmits an application creation instruction to the information processing system 20 at step S614.

In the information processing system 20, when the communication unit 21 receives the application creation instruction, the application creator 25 creates the application at step S615. In the information processing system 20, the display controller 22 transmits an instruction to update the application creation screen to the user terminal 10 via the communication unit 21 at step S616.

The update instruction includes, for each field, a field name, a data type of a value of the field, and information indicating the position where the field is displayed. The information included in the update instruction is update information transmitted from the information processing system 20 to the user terminal 10 to cause the update of the application creation screen displayed on the user terminal 10.

When the user terminal 10 receives the update instruction to update the application creation screen, at step S617, the display controller 12 displays the application creation screen so that the components included in the created application are displayed on the application creation screen. More specifically, the user terminal 10 causes the display controller 12 to display the field name and the component associated with the field name at the designated position on the application creation screen.

The display controller 22 of the information processing system 20 updates the application creation screen, by transmitting, to the user terminal 10, the field name and the position of each field. The field name is based on the identification information for identifying each of the components included in the created application, and the position of each field is based on the arrangement information indicating the position of each component.

At step S618, the information processing system 20 stores the application management information of the created application in the application management table 42, and stores the created application in the application storage unit 27.

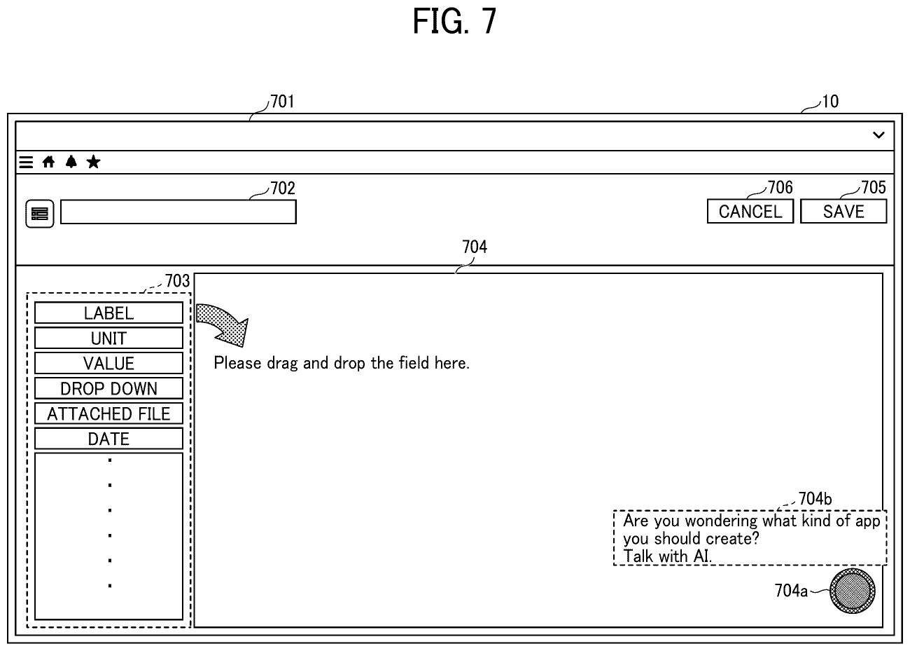

An example of a screen displayed by the user terminal 10 will be described below. FIG. 7 is a diagram illustrating a first example of a screen displayed on the user terminal according to the first embodiment. The screen 701 illustrated in FIG. 7 is an example of the screen displayed on the user terminal 10 at step S603 of FIG. 6.

The screen 701 is displayed on the user terminal 10, for example, in response to a user operation on a home screen of the application creation system 100 displayed on the user terminal 10.

The screen 701 includes an entry field 702, display areas 703 and 704, and operation buttons 704a, 705, and 706. The entry field 702 is an input field for inputting the name of the application to be created using the application creation screen.

The display area 703 displays a list of icon images each indicating the data type of the component associated with the field. The display area 704 is used for creating the application, and displays the application being created or the application that is created.

In response to the user operation, the user terminal 10 selects a particular icon image from the list of icon images displayed in the display area 703 and moves the selected icon image to the display area 704, to cause the display area 704 to display the component having the data type indicated by the selected icon image. Further, in response to the user operation, the user terminal 10 associates the component displayed in the display area 704 with the field name managed by the application. As described above, the user of the user terminal 10 selects the particular icon image from the list of icon images displayed in the display area 703, and performs an operation of dragging and dropping the selected icon image to the display area 704, to cause the display area 704 to display the component having a data type indicated by the selected icon image.

In this manner, the application can be created by arranging the components associated with the field names managed by the application in the display area 704. For example, in the display area 704, the component is associated with the field name managed by the application, so that the data type of the value of the field is input in a data type selected in the display area 703.

The display area 704 includes the operation button 704a and a display area 704b. The operation button 704a, when selected, displays the chat window. The display area 704b displays a message for notifying the user that the user can request the generative AI system 50 to assist the user in creating the application.

The operation button 705, when selected, saves the application being created or the application that has been created, which is displayed in the display area 704. Specifically, the operation button 705, when selected, stores the application displayed in the display area 704 in the application storage unit 27, and further stores the application management information of the application being displayed in the display area 704 in the application management table 42. The operation button 706, when selected, cancels the creation of the application.

When an operation of selecting the operation button 704a is performed, the user terminal 10 displays the chat window as a pop-up window.

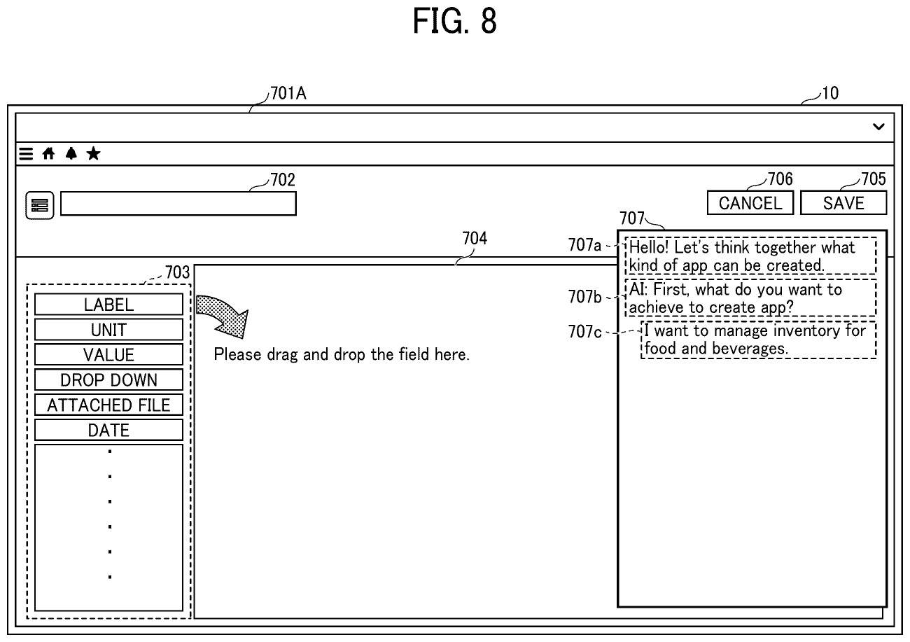

FIG. 8 is a diagram illustrating a second example of a screen displayed on the user terminal according to the first embodiment. The screen 701A illustrated in FIG. 8 is an example of the application creation screen displayed on the user terminal 10 at step S605 of FIG. 6.

The screen 701A of FIG. 8 illustrates a chat window 707, which is displayed as the pop-up window on the screen 701 illustrated in FIG. 7.

The chat window 707 is displayed on the display 506 at a position, so that the user can input a chat message while viewing the display area 704 used for creating the application. In other words, the chat window 707 is displayed on the screen simultaneously with the display area 704 used for creating the application.

The display area 704 and the chat window 707 are displayed side by side on the display 506 to allow the user to easily compare. Accordingly, the user can create the application while receiving the support from the generative AI system 50, and the burden on the user is reduced. Since the display area 704 used for creating the application and the chat window 707 are both displayed on the display 506 in a manner visually recognizable by the user, it is not necessary to switch between the display area 704 and the chat window 707 on the screen.

The chat window 707 illustrated in FIG. 8 includes display areas 707a, 707b, and 707c. The messages displayed in the display areas 707a and 707b are automatically displayed when the operation button 704a is selected on the screen 701 illustrated in FIG. 7 and the chat window 707 is displayed. In other words, the messages displayed in the display areas 707a and 707b are messages previously included in the screen information of the application creation screen.

The display area 707c displays the chat messages related to the creation of the application, which are input by the user of the user terminal 10. In FIG. 8, the chat message “I want to manage the inventory for food and beverages” is input as a chat message related to the creation of the application.

When the chat message related to the creation of the application is input from the user, the information processing system 20 causes the controller 23 to generate the prompt and transmits the prompt to the generative AI system 50.

The chat window 707 is displayed when the operation button 704a of FIG. 7 is selected, but the present embodiment is not limited to this example. For example, the application creation screen of FIG. 7 may initially display the chat window 707 instead of the operation button 704a.

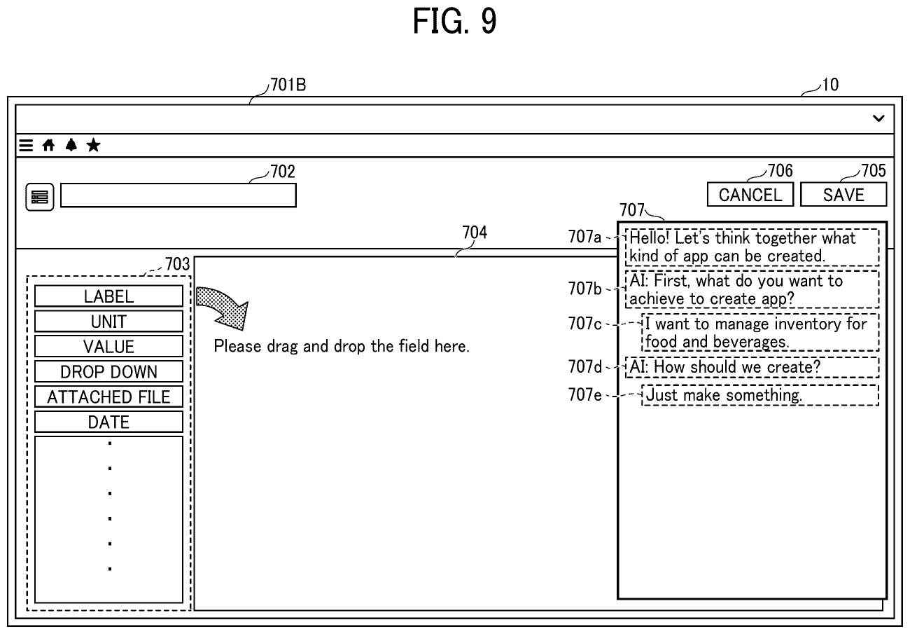

Further, the screen information of the application creation screen may include a message for prompting the user to input a chat message in addition to the messages displayed in the display areas 707a and 707b. Another example operation performed by the application creation system 100 will be described below with reference to FIG. 9.

FIG. 9 is a diagram illustrating a third example of a screen displayed on the user terminal according to the first embodiment. In the screen 701B illustrated in FIG. 9, the chat window 707 displays the display areas 707d and 707e in addition to the display areas 707a, 707b, and 707c.

The display area 707d displays the message “How should we create?” as a message for causing the user to additionally input a chat message related to the creation of the application.

The display area 707e displays the chat message input by the user of the user terminal 10 in response to the message displayed in the display area 707d. In FIG. 9, the user of the user terminal 10 inputs the chat message “Just make something” as the chat message related to the creation of the application.

When the chat message related to the creation of the application is input from the user in the chat window 707, the information processing system 20 generates the prompt to be transmitted to the generative AI system 50.

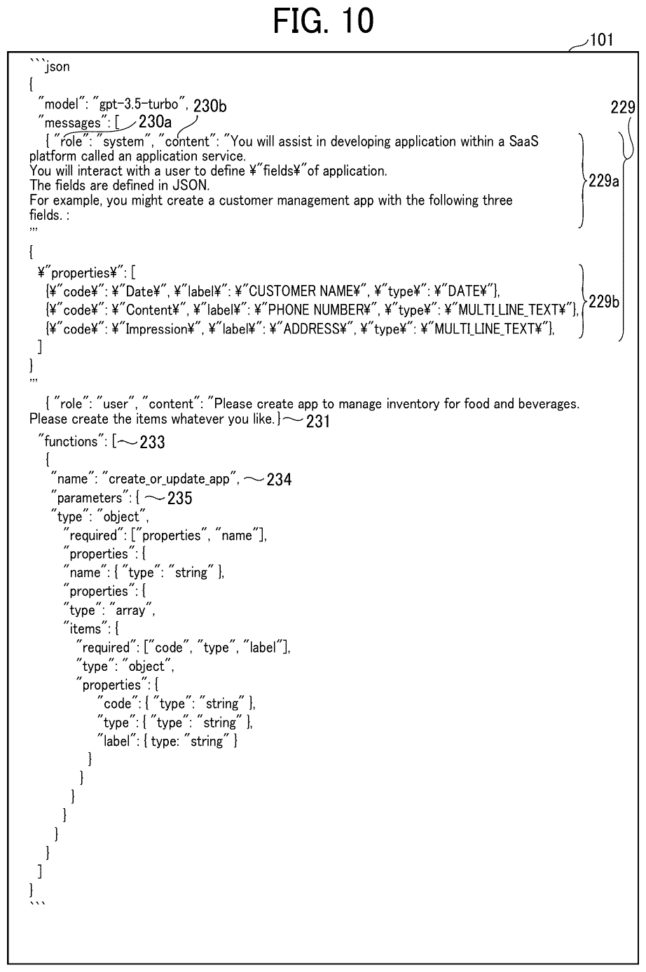

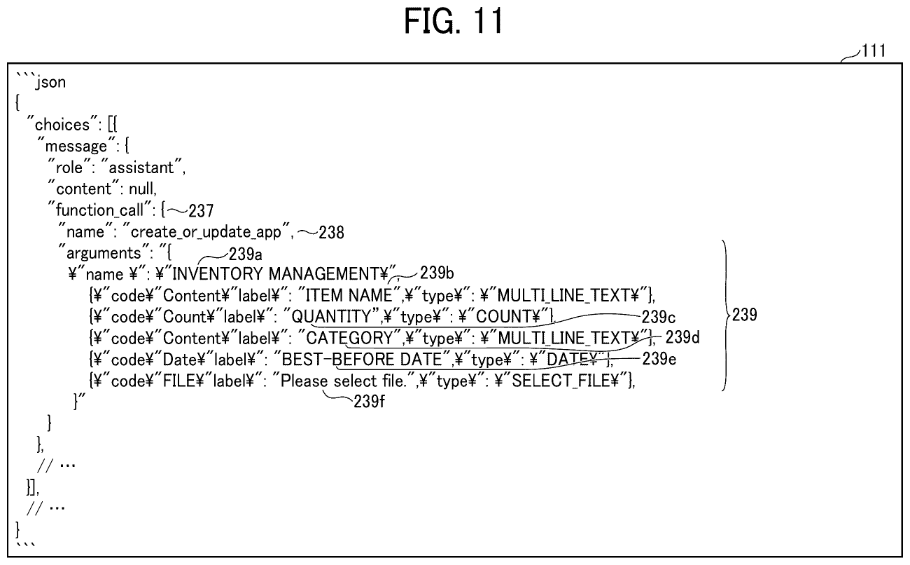

An example of the prompt generated by the information processing system 20 and an example of the response message received by the information processing system 20 from the generative AI system 50 will be described with reference to FIGS. 10 and 11.

FIG. 10 is a diagram illustrating an example of the prompt. The prompt 101 illustrated in FIG. 10 is an example of a prompt generated by the controller 23 at step S608 of FIG. 6, and transmitted to the generative AI system 50.

The prompt 101 includes role 230a and content 230b. The role 230a indicates a speaker, and includes “user”, “assistant” (AI of the generative AI system 50), and “system” (instructing settings of AI assistant). The content 230b indicates the conversation contents, and may be written in the natural language.

For example, the speaker indicated by the role 230a may be the information processing system 20, and the conversation contents indicated by the content 230b may be the contents previously set in the information processing system 20.

The prompt 101 further includes system setting 229 by the system. The system setting 229 may include data 229a, which is a message “You will assist in developing application within a SaaS platform called an application service. You will interact with a user to define “fields” of application. The fields are defined in JSON. For example, you might create a customer management application with the following three fields”.

The system setting 229 further includes data 229b indicating the fields “customer name”, “phone number”, and “address” as field names. The data types of these fields are respectively set to DATE, MULTI_LINE_TEXT, and MULTI_LINE_TEXT. The data 229a and the data 229b are based on the setting data, which is previously transmitted to the information processing system 20 according to an instruction from the developer.

The prompt 101 further includes a text message 231 that requests creation of the application based on the chat message input by the user, such as “Please create app to manage inventory for food and beverages. Please create the items whatever you like.” This text message is generated by, for example, inserting the chat message input to the user terminal 10 into a template previously stored in the application creator 25. Alternatively, the text message may be the chat message input to the user terminal 10 by the user.

The prompt 101 of FIG. 10 further includes a function specification setting 233, which is represented as “functions”. In the function specification setting 233, name 234 is the name of the function. The parameters 235 is a part of the specification of the function. “type”: “object” indicates the data type of the return value. “required”: [“properties”, “name”] indicates the item name required for the return value. “name”: {“type”: “string”} indicates the data type of name. “type”: “array” indicates that the format is a table format. “items” and the description below “items” indicate the properties and data types required for the field.

With the function specification setting 233, the generative AI system 50 returns a response message requesting the information processing system 20 to call a function defined as illustrated in FIG. 10.

An example of a response from the generative AI system 50 to the information processing system 20 will be described below with reference to FIG. 11.

FIG. 11 is a diagram illustrating an example of a response message transmitted from the generative AI system in response to the prompt. The response message 111 illustrated in FIG. 11 is output from the generative AI system 50 to the information processing system 20 at step S610 of FIG. 6.

The response message 111 includes a function call request 237. When the function call is included in the response message, the information processing system 20 creates an application.

The function call request 237 of the response message corresponds to the request to create the application. The function call request 237 includes name 238 and arguments 239. The name 238 is the name of the function defined in the function specification setting 233. The generative AI system 50 requests the information processing system 20 to call the function having this name. arguments 239 is a return value, and is defined in the function specification setting 233. In FIG. 11, the arguments 239, which are the return value, include the application name “inventory management” 239a, the field names 239b, 239c, 239d, 239e, and 239f included in the inventory management application, and the data types (DATE, MULTI_LINE_TEXT) of these fields.

The generative AI system 50 designates the field names selected at the user terminal 10 using the function call, and requests the information processing system 20 to call the function for creating the application.

The information processing system 20 analyzes the function call included in the response message 111 and creates the application (execution of a function). Specifically, the information processing system 20 creates the application using the field names and the data types (an example of parameters) included in the response message 111. When the creation of the application is successful, the information processing system 20 acquires a URL that is a storage destination of the application, and transmits the URL to the user terminal 10. The URL is access information for the user terminal 10 to access the application.

When the information processing system 20 receives the response message 111 illustrated in FIG. 11, the controller 23 transmits the parameters included in the response message to the user terminal 10 and causes the user terminal 10 to display the parameters. The parameters included in the response message include a field name managed by the application.

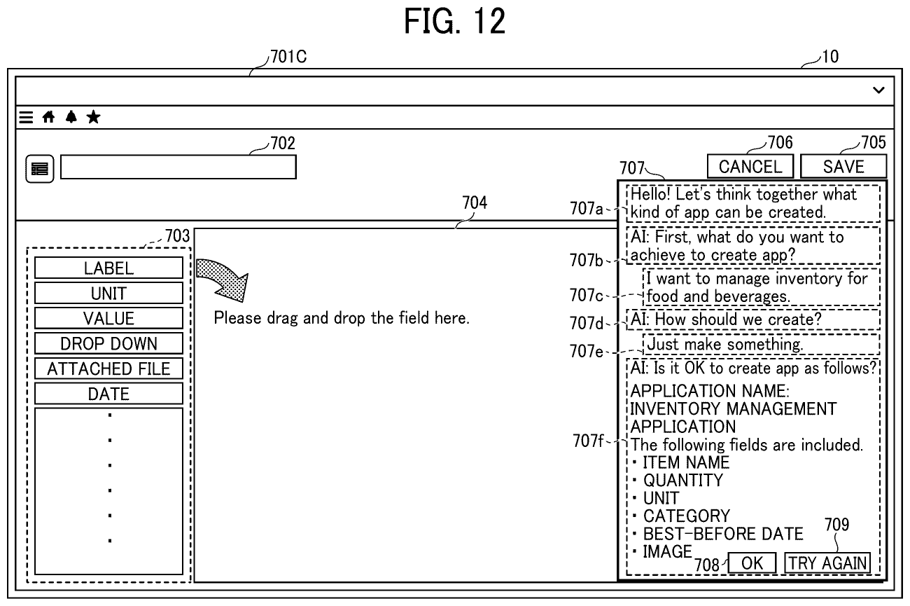

An operation of displaying a confirmation message of an application to be created will be described below with reference to FIG. 12. FIG. 12 is a diagram illustrating a fourth example of a screen displayed on the user terminal according to the first embodiment.

The screen 701C illustrated in FIG. 12 is an example of the screen displayed on the user terminal 10 at step S612 of FIG. 6. In the screen 701C illustrated in FIG. 12, the chat window 707 includes a display area 707f in addition to the display areas 707a, 7076, 707c, 707d, and 707e.

The display area 707f displays a confirmation message for confirming an application to be created, which is received by the user terminal 10 from the information processing system 20. The confirmation message includes a list of fields managed by the application to be created. In other words, the display area 707f displays a list of fields that are parameters included in the response message from the generative AI system 50.

The display area 707f further displays the name of the application to be created. The name of the application may be a name entered in the entry field 702 or a name automatically generated by the generative AI system 50.

In FIG. 12, “inventory management application” is displayed as the name of the application. Further, an item name, a quantity, a unit, a category, a best-before date, and an image are displayed as a list of fields managed by the application.

The display area 707f further includes operation buttons 708 and 709. The operation button 708, when selected, instructs creation of the application with the content indicated by the confirmation message. The operation button 709, when selected, allows the user to re-create the application.

When the operation button 709 is selected on the screen 701C, the user terminal 10 hides the chat window 707 from the screen 701C and displays the screen 701 illustrated in FIG. 7. When the operation button 709 is selected on the screen 701C, the user terminal 10 may hide the display areas of the chat window 707 other than the display areas 707a and 707b.

When the operation button 708 is selected on the screen 701C, the user terminal 10 transmits an application creation instruction to the information processing system 20, and displays an application creation result on the display area 704.

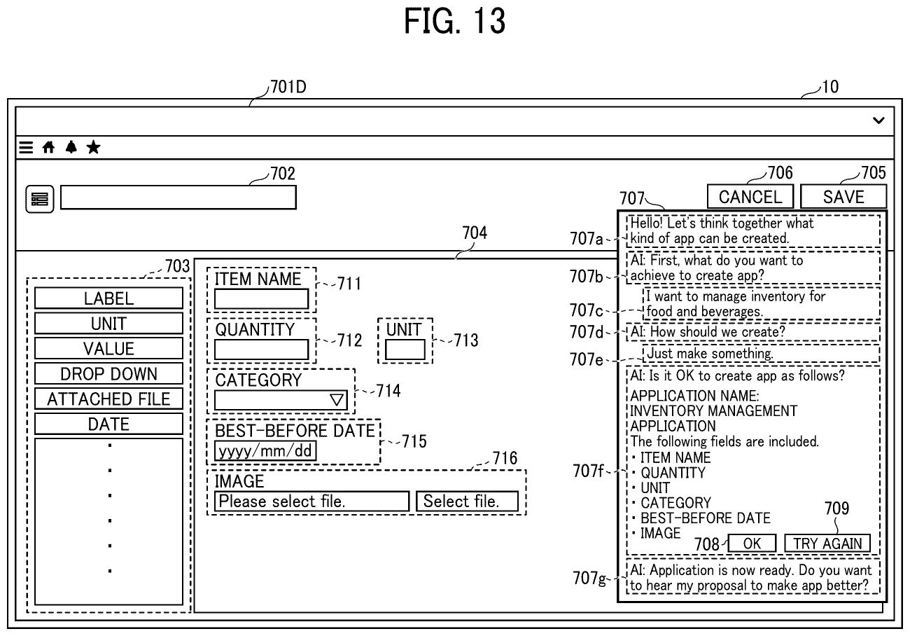

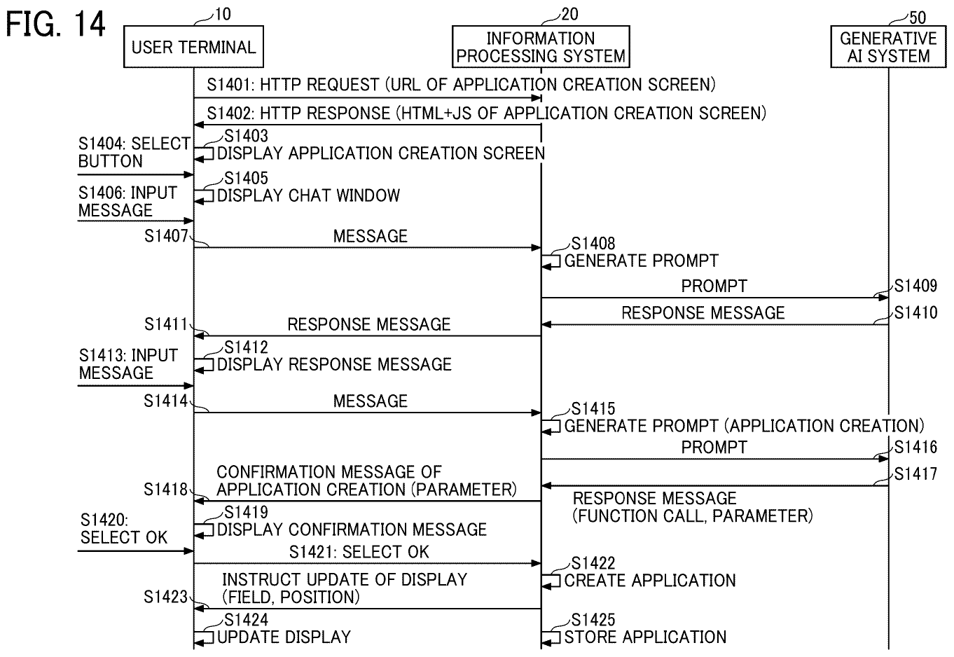

An operation of displaying the application creation result is described below with reference to FIG. 13. FIG. 13 is a diagram illustrating a fifth example of a screen displayed on the user terminal according to the first embodiment.

The screen 701D illustrated in FIG. 13 is an example of the screen displayed on the user terminal 10 at step S617 of FIG. 6. In the screen 701D illustrated in FIG. 13, the chat window 707 includes a display area 707g in addition to the display areas 707a, 707b, 707c, 707d, 707e, and 707f.

The display area 704 further displays, as a result of creating the application, a field name and a component associated with the field name for each field managed by the application. In other words, in the screen 701D, the display content of the display area 704 is updated. Specifically, the display area 704 includes display areas 711, 712, 713, 714, 715, and 716.

The display area 711 displays the field name “item name” and the component associated with the field name “item name”. A data type of data input to the component is preset to “MULTI_LINE_TEXT”.

The display area 712 further displays the field name “quantity” and the component associated with the field name “quantity”. A data type of data input to this component is preset to “COUNT”. Similarly, the display areas 713 to 716 each displays the field name and the component associated with the field name, and the component is preset with a data type of data to be input.

In the screen 701D, the display area 707g of the chat window 707 displays a message indicating that the application has been created. The display area 707g may display a message that proposes improvement of the application using the generative AI system 50.

In the present embodiment, the display area 704 used for creating the application and the chat window 707 are simultaneously displayed to the user. Accordingly, the application creation result and the chat window 707 are simultaneously presented to the user. The user can input a chat message to the generative AI system 50 while referring to the application creation result. For example, the user can create the application while asking questions to the generative AI system 50.

### First Modification

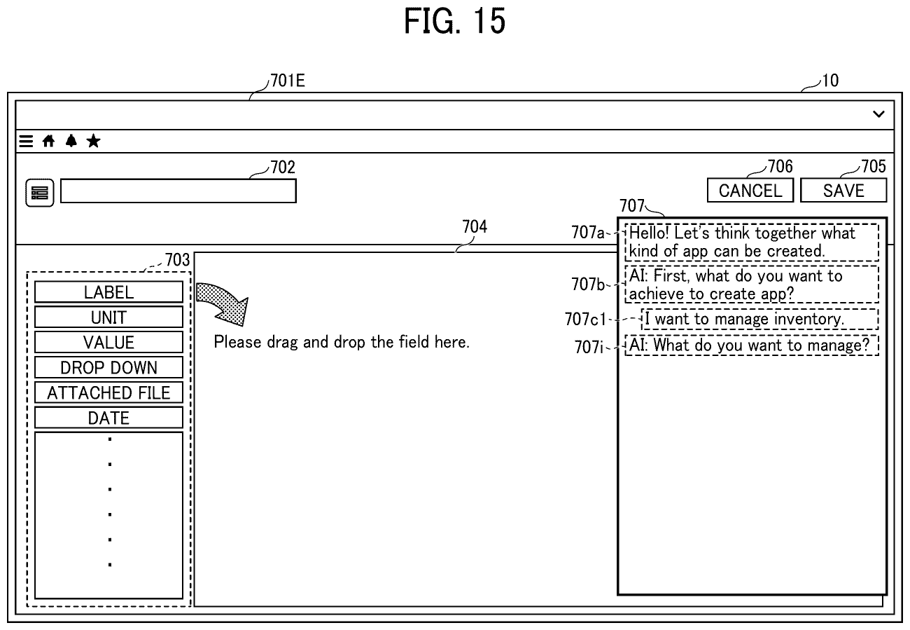

The application creation system 100 according to the first modification of the first embodiment is described below with reference to FIGS. 14 and 15. The first modification of the first embodiment is different from the first embodiment in that the chat window 707 displays the questions for causing the user to input information used for creating the application. In the following description of the first modification of the first embodiment, differences from the first embodiment are described. The same reference numerals are given to the same or corresponding functions or configurations as those of the first embodiment, and redundant descriptions thereof are omitted or simplified appropriately.

FIG. 14 is a sequence diagram illustrating an example operation performed by the application creation system 100 according to the first modification of the first embodiment.

Since the processes from step S1401 to step S1407 of FIG. 14 are the same as the processes from step S601 to step S607 of FIG. 6, the description thereof is omitted.

In the information processing system 20, when the chat message reception unit 21a of the communication unit 21 receives the chat message at S1407, at step S1408, the controller 23 generates a prompt for requesting display of the received chat message and information used for creating an application that is requested by the chat message. At step S1409, the transmission unit 23a of the information processing system 20 transmits the prompt to the generative AI system 50.

At step S1410, in the information process system 20, the reception unit 23b of the controller 23 receives the response message from the generative AI system 50. The response message being received is a message prompting the user to input information used for creating the application.

In response to receiving the response message, at step S1411, the communication unit 21 of the information processing system 20 transmits the response message to the user terminal 10. At step S1412, the display controller 12 displays the response message received from the information processing system 20. When the operation reception unit 13 receives an input of a chat message from the user at step S1413, the communication unit 11 of the user terminal 10 transmits the chat message to the information processing system 20 at step S1414.

For example, when the message prompting the user to input information used for creating the application is displayed a predetermined number of times, the information processing system 20 proceeds to step S1415 to be described later. The information processing system 20 may repeat the processes from step S1408 to step S1414 until the information processing system 20 receives a response message indicating that the application is to be created from the generative AI system 50.

The information processing system 20 proceeds to step S1414 following step S1415.

Since the processes from S1415 to S1425 of FIG. 14 are the same as the processes from S608 to S618 of FIG. 6, the description thereof is omitted.

FIG. 15 is a diagram illustrating an example of a screen displayed on the user terminal according to the first modification of the first embodiment. The screen 701E illustrated in FIG. 15 is an example of a screen displayed on the user terminal 10 at step S1412 of FIG. 14.

In the screen 701E, the chat window 707 includes display areas 707a, 707b, 707c1, and 707i.

The display area 707c1 displays the chat message input by the user at step S1406 of FIG. 14. The display area 707i displays the response message output from the generative AI system 50. The response message displayed in the display area 707i is a message (question) for causing the user to input information used for creating the application.

Specifically, the display area 707c1 displays the message “I want to manage inventory”. The display area 707i displays the message “What do you want to manage?”. When creating the application with the generative AI system 50, the user terminal 10 displays information to be confirmed, while prompting the user to input additional information. The user can create the application by simply answering the question displayed in the chat window 707.

### Second Modification

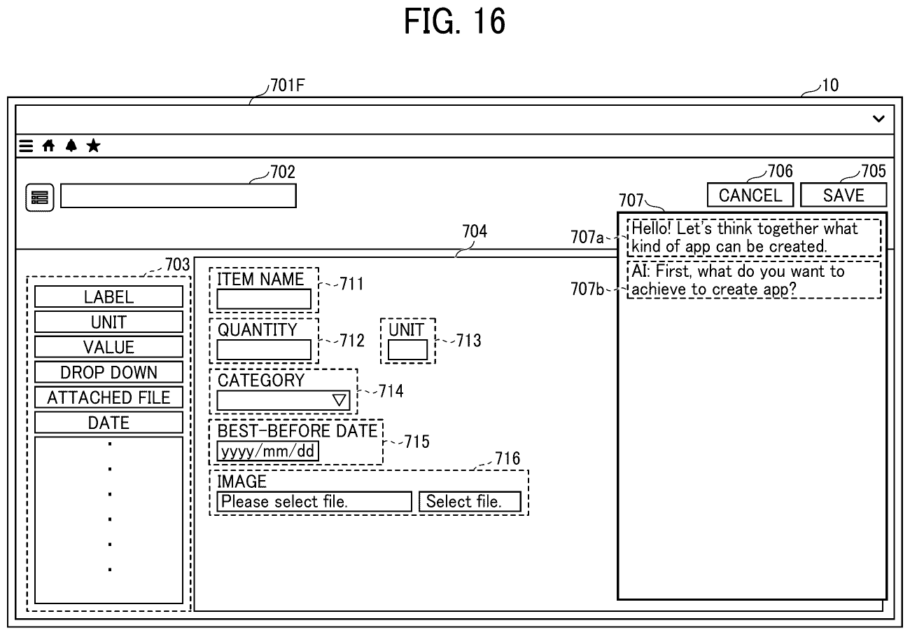

The application creation system 100 according to the second modification of the first embodiment is described below with reference to FIGS. 16 to 19. The second modification of the first embodiment is different from the first embodiment in that, while the display area 704 is displaying the components associated with the field names, the application creation system 100 can receive an instruction to create the application including the field names and the components displayed in the display area 704. In the following description of the second modification of the first embodiment, differences from the first embodiment are described. The same reference numerals are given to the same or corresponding functions or configurations as those of the first embodiment, and redundant descriptions thereof are omitted or simplified appropriately.

FIG. 16 is a diagram illustrating a first example of a screen displayed on the user terminal according to the second modification of the first embodiment. The screen 701F illustrated in FIG. 16 is an example of an application creation screen displayed on the user terminal 10 in response to the user selecting to re-create the application when the application to be created is displayed on the user terminal 10 at step S617 of FIG. 6. In other words, the screen 701F illustrated in FIG. 16 is an example of a screen displayed on the user terminal 10 when the operation button 709 is selected on the screen 701D illustrated in FIG. 13.

On the screen 701F, the display area 704 includes the display areas 711 to 716 each displaying the component associated with the field name.

In a case where a chat message related to the creation of the application is input, while the components and the fields are displayed in association in the display area 704, the application creation system 100 creates the application including the fields having been associated with the components as a control target. More specifically, when the chat message related to the creation of the application is input while the components and the fields are displayed in association, the information processing system 20 generates a prompt to create the application including the fields having been associated with the components. The information processing system 20 then transmits the generated prompt to the generative AI system 50.

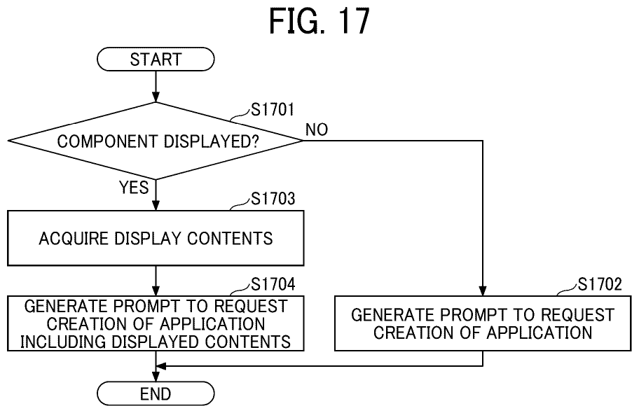

An example operation of generating a prompt performed by the information processing system 20 will be described with reference to FIG. 17. FIG. 17 is a flowchart of processing performed by the information processing system 20 according to the second modification of the first embodiment. FIG. 17 illustrates the details of the process performed at step S608 of FIG. 6 in the second modification of the first embodiment.

In the information process system 20, when the chat message related to the creation of the application is input from the user terminal 10, the controller 23 determines whether the components are displayed in the display area 704 at step S1701.

When no component is displayed in the display area 704 at step S1701 (“NO” at S1701), the controller 23 generates a prompt including the chat message received from the user terminal 10 and an instruction to generate the parameters related to the creation of the application based on the chat message at step S1702, and the operation proceeds to step S609 of FIG. 6.

When the components are displayed in the display area 704 at step S1701, the controller 23 acquires information indicating the content displayed in the display area 704 at step S1703.

The example case where the components associated with the field names are displayed in the display area 704 will be described below. The controller 23 acquires, as information indicating the display content, information indicating the field names displayed in the display area 704, the data types preset for the components associated with the field names, and the information indicating the positions of the components associated with the field names.

The controller 23 generates a prompt including the display content and instructing the creation of the application at step S1704, and the operation proceeds to step S609 of FIG. 6.

In other words, the prompt being generated includes an instruction to generate the parameters that include the field names associated with the components, the information indicating the positions of the components associated with the field names, and the data types preset for the components associated with the field names, based on the chat message.

The information processing system 20 generates the prompt in this manner. In response to receiving the response message including the parameters and the function call from the generative AI system 50, the information processing system 20 transmits the parameters included in the response message to the user terminal 10 for display at the user terminal 10.

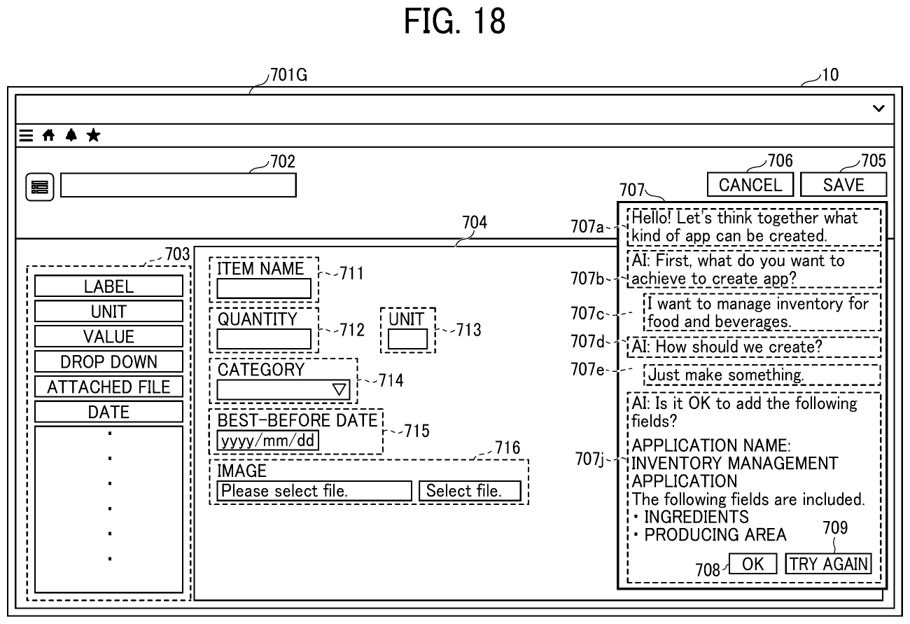

The example of displaying a response message from the generative AI system 50 in a case where the display area 704 displays the components in association with the field names will be described below with reference to FIG. 18.

FIG. 18 is a diagram illustrating a second example of a screen displayed on the user terminal according to the second modification of the first embodiment. The screen 701G illustrated in FIG. 18 is an example of a screen displayed on the user terminal 10 at step S612 of FIG. 6 in the second modification of the first embodiment.

On the screen 701G, the chat window 707 displays a display area 707j in addition to the display areas 707a, 707b, 707c, 707d, and 707e.

The display area 707j displays a confirmation message for confirming the fields to be added to the application to be created. The confirmation message includes a list of fields to be added to the fields associated with the components being displayed in the display area 704. In other words, the display area 707j displays a list of fields to be added to the currently created application, which are the parameters included in the response message that is transmitted from the generative AI system 50 in response to the prompt received at the generative AI system 50 at step S609.

In FIG. 18, the display area 707j displays the message “The following fields are included. INGREDIENTS, PROUCING AREA”, indicating that the fields such as the ingredients and the producing area are proposed to be added to the fields managed by the inventory management application having the fields being displayed in the display area 704.

The display area 707j includes operation buttons 708 and 709. In response to an operation of selecting the operation button 708 on the screen 701G, the user terminal 10 transmits an instruction to create the application to the information processing system 20 that accepts the proposal for adding the fields. The information processing system 20 creates the application that additionally include the fields displayed in the display area 707j. The result of creating the application is displayed on the user terminal 10.

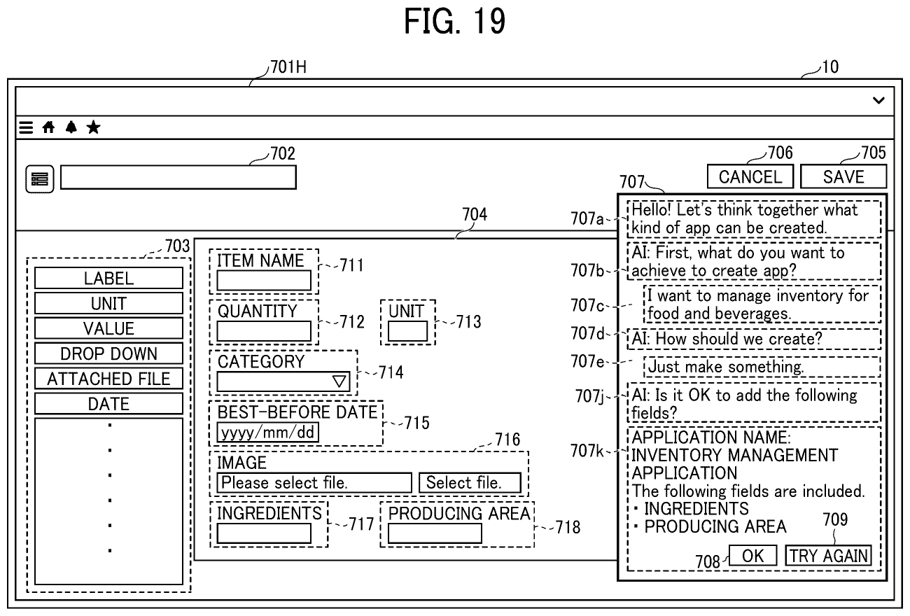

FIG. 19 is a diagram illustrating a third example of a screen displayed on the user terminal according to the second modification of the first embodiment. The screen 701H illustrated in FIG. 19 is an example of a screen displayed on the user terminal 10 at step S617 of FIG. 6 in the second modification of the first embodiment.

On the screen 701H, the display area 704 additionally includes a display area 717 displaying the component associated with the field name “ingredients”, and a display area 718 displaying the component associated with the field name “producing area”. In other words, the display content in the display area 704 of FIG. 19 is updated from the display content in the display area 704 of FIG. 18.

As described above, the application creation system 100 allows the user to add the fields to the application that has been created once, with the assistance from the generative AI system 50.

### Third Modification

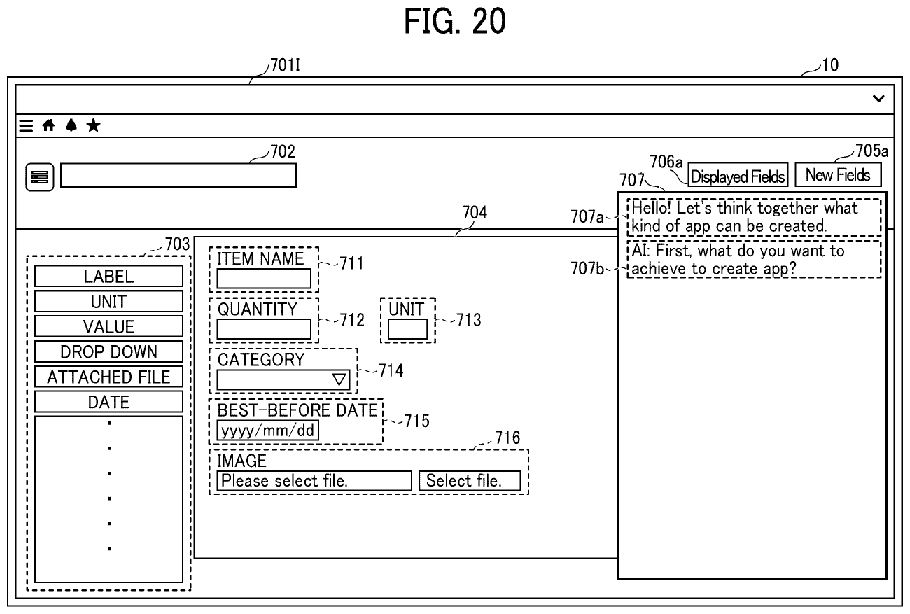

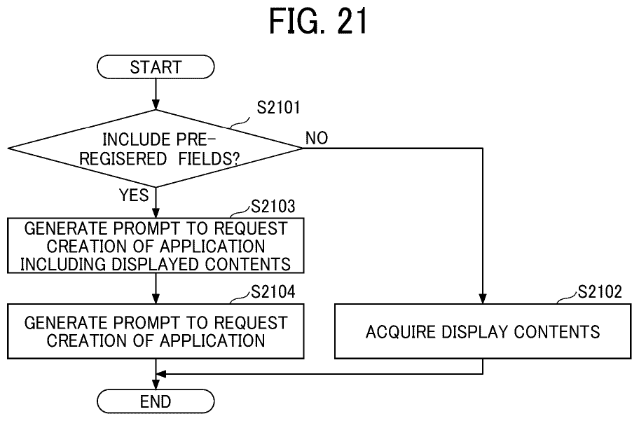

The application creation system 100 according to the third modification of the first embodiment is described below with reference to FIGS. 20 and 21. The third modification of the first embodiment is different from the second modification of the first embodiment in that, when starting to create the application, the application creation system 100 allows the user to select whether to newly generate the application or to generate the application including the fields managed by the pre-registered application. In the following third modification, the differences from the second modification will be described.

FIG. 20 is a diagram illustrating an example of a screen displayed on the user terminal according to the third modification of the first embodiment. The screen 701I illustrated in FIG. 20 is an example of an application creation screen displayed on the user terminal 10 in response to the user selecting to re-create the application when the application to be created is displayed on the user terminal 10 at step S617 of FIG. 6. In other words, the screen 701I illustrated in FIG. 20 is an example of a screen displayed on the user terminal 10 when the operation button 709 is selected on the screen 701D illustrated in FIG. 13.

On the screen 701I, the display area 704 includes the display areas 711 to 716 each displaying the component associated with the field name.

The screen 701I further includes operation buttons 705a and 706a. The operation button 705a, when selected, allows the user to create the application having the fields associated with the components displayed in the display area 704 as a control target. The operation button 706a, when selected, allows the user to create the application while not taking into account the fields associated with the components in the display area 704. In other words, the operation buttons 705a and 706a together function as a user interface that allows the user to select whether to include the pre-registered fields in the application to be created.

When an operation of selecting the operation button 705a is performed on the screen 701I, and the chat message related to the creation of the application is input, the information processing system 20 creates the application including the fields associated with the components displayed in the display area 704 as the control target. More specifically, the information processing system 20 generates a prompt for creating the application including the fields associated with the components displayed in the display area 704 as the control target, and transmits the generated prompt to the generative AI system 50.

The operation of selecting the operation button 705a or the operation button 706a is performed, for example, when inputting the chat message related to the creation of the application.

An example operation of generating a prompt performed by the information processing system 20 will be described with reference to FIG. 21. FIG. 21 is a flowchart of processing performed by the information processing system 20 according to the third modification of the first embodiment. FIG. 21 illustrates the details of the process performed at step S608 of FIG. 6 in the third modification of the first embodiment.

In the information processing system 20, when the chat message related to the creation of the application is input from the user terminal 10, the controller 23 determines whether to cause the application to be created to include the pre-registered fields at step S2101. The pre-registered fields are the fields that are previously used for the previously-created application.

Specifically, when the operation button 705a is selected on the screen 701I at the user terminal 10, the controller 23 determines that the pre-registered fields are to be included in the application. When the operation button 706a is selected on the screen 701I at the user terminal 10, the controller 23 determines that the pre-registered fields are not to be included.

When the operation button 706a is selected at step S2101, that is, when it is determined that the pre-registered fields are not to be taken into account (“NO” at S2101), the controller 23 proceeds to step S2102.

When the operation button 705a is selected at step S2101, that is, when it is determined that the pre-registered fields are to be included in the application (“YES” at S2101), the controller 23 proceeds to step S2103.

Since the processes from S2102 to S2104 of FIG. 21 are the same as the processes from S1702 to S1704 of FIG. 17, the description thereof is omitted.

As described above, the application creation system 100 allows the user to select whether to include the fields associated with the components in the display area 704 as the control target of the application to be created.

For example, the user may cause the user terminal 10 to display the fields for the application having been created in the past in the display area 704, and instruct to create another application by using the fields managed by the application created in the past.

### Second Embodiment

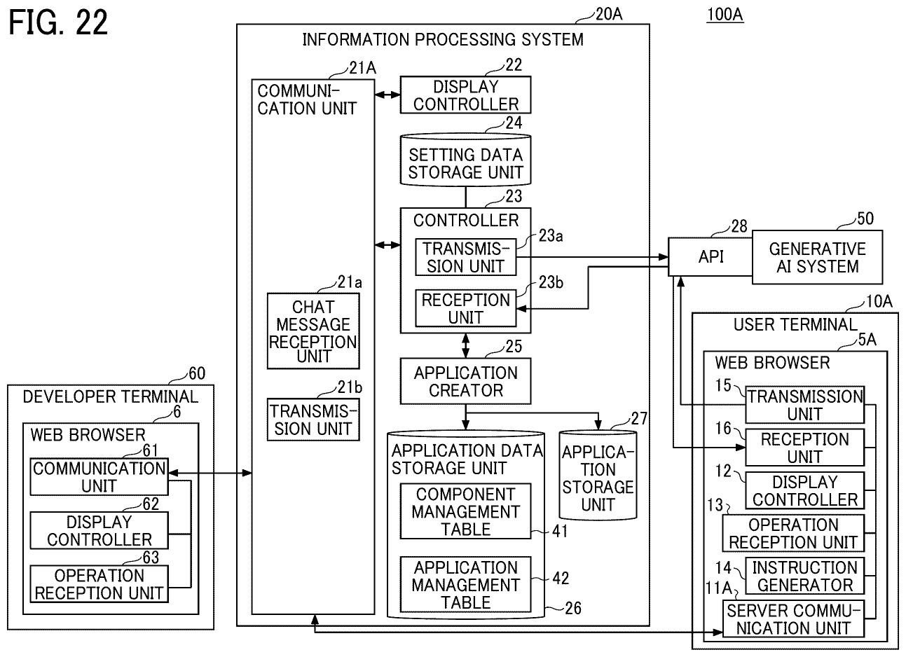

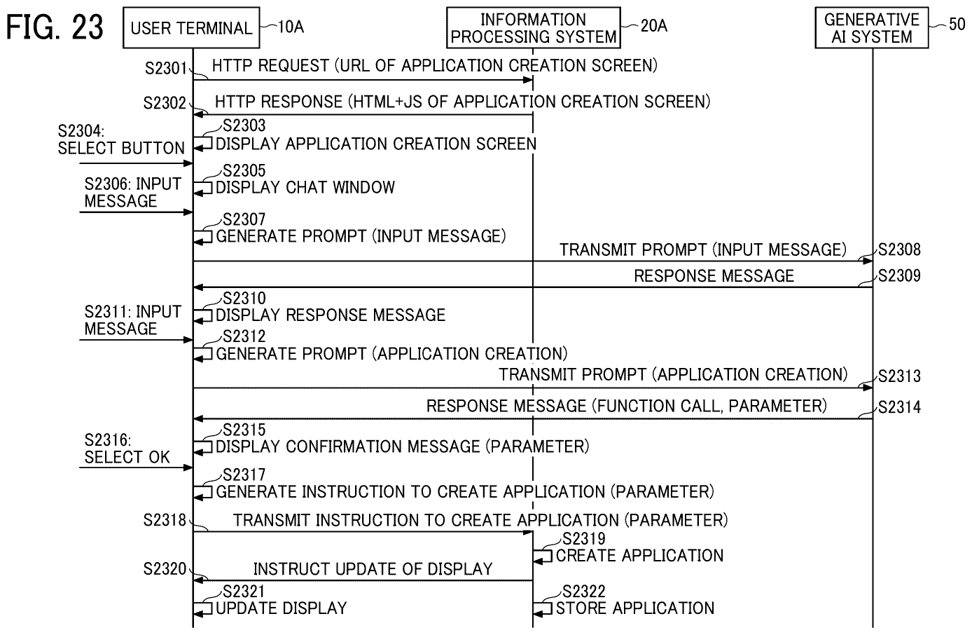

An application creation system 100A according to the second embodiment is described below with reference to FIGS. 22 and 23. The differences between the application creation system 100 of the first embodiment and the application creation system 100A of the second embodiment include that a prompt to be transmitted to the generative AI system 50 is generated at a user terminal 10A. In the following description of the second embodiment, the differences from the first embodiment are described. The same reference numerals are given to the same or corresponding functions or configurations as those of the first embodiment, and redundant descriptions thereof are omitted or simplified appropriately.

FIG. 22 is a diagram illustrating functions performed by each apparatus included in the application creation system 100A according to the second embodiment.

The application creation system 100A includes the user terminal 10A, an information processing system 20A, the generative AI system 50, and the developer terminal 60.

The information processing system 20A includes a communication unit 21A in alternative to the communication unit 21. The communication unit 21A includes the chat message reception unit 21a and a transmission unit 21b. The transmission unit 21b transmits the screen information of the application creation screen to the user terminal 10A. The transmission unit 21b transmits update information for updating the application creation screen to the user terminal 10A. The transmission unit 21b is an example of a second transmission unit and a third transmission unit.

The user terminal 10A includes a server communication unit 11A, the display controller 12, the operation reception unit 13, an instruction generator 14, a transmission unit 15, and a reception unit 16, each of which is implemented by a web browser 5A.

The server communication unit 11A communicates with the information processing system 20. For example, the server communication unit 11A receives the screen information of the application creation screen from the information processing system 20. In other words, the server communication unit 11A receives the web content including the HTML and the JavaScript®. The JavaScript® included in the web content is an example of a program received by the server communication unit 11A from the information processing system 20.

The instruction generator 14 generates a prompt to be transmitted to the generative AI system 50 according to an operation on the user terminal 10A. In other words, the instruction generator 14 generates an instruction to be transmitted to the generative AI system 50.

The transmission unit 15 transmits the prompt generated by the instruction generator 14 to the generative AI system 50. The reception unit 16 receives, from the generative AI system 50, a response message that corresponds to the prompt transmitted to the generative AI system 50.

The instruction generator 14, the transmission unit 15, and the reception unit 16 are each implemented by, for example, JavaScript® received from the information processing system 20 at the server communication unit 11A.

The function of the instruction generator 14 is implemented by executing the JavaScript® for the instruction generator 14. The function of the transmission unit 15 is implemented by executing the JavaScript® for the transmission unit 15. The function of the reception unit 16 is implemented by executing the JavaScript® for the reception unit 16.

An example operation performed by the application creation system 100A will be described below with reference to FIG. 23. FIG. 23 is a sequence diagram illustrating an example operation performed by the application creation system 100A according to the second embodiment.

Since the processes from step S2301 to step S2306 of FIG. 23 are the same as the processes from step S1401 to step S1406 of FIG. 14, the description thereof is omitted.

When the chat message related to the creation of the application is input at step S2306, the instruction generator 14 of the user terminal 10A generates a prompt including the chat message at S2307. The prompt being generated is, for example, a prompt for requesting display of the input chat message and information used for creating the application that is requested by the chat message. The prompt being generated may be the same as the prompt being generated at step S1408 of FIG. 14.

The transmission unit 15 of the user terminal 10A transmits a prompt including the input chat message to the generative AI system 50 at step S2308. The reception unit 16 of the user terminal 10A receives the response message from the generative AI system 50 at step S2309.

Since the processes of step S2310 and step S2311 of FIG. 23 are the same as the processes of step S1412 and step S1413 of FIG. 14, the description thereof is omitted.

When the chat message is input, the instruction generator 14 of the user terminal 10A generates a prompt for creating the application at step S2312. The transmission unit 15 transmits the generated prompt to the generative AI system 50 at step S2313.

The prompt transmitted to the generative AI system 50 at step S2313 is the same as the prompt generated by the information processing system 20 at step S1408 of FIG. 14.

The reception unit 16 of the user terminal 10A receives a response message, which is transmitted from the generative AI system 50 in response to the prompt for creating the application at step S2314.

This response message received by the user terminal 10A is the same as the response message received by the information processing system 20 from the generative AI system 50 at step S1410 of FIG. 14. In other words, the response message received by the user terminal 10A is a request generated by the generative AI system 50 based on the prompt, and includes the parameters related to the creation of the application and names of the functions for identifying the function for causing execution of the application creator 25.

The display controller 12 of the user terminal 10A displays a confirmation message for confirming the application to be created at step S2315. The screen information of the application creation screen includes JavaScript® that defines that, when a response message including the function call is received, the parameters included in the response message are displayed as a confirmation message. The confirmation message is displayed by the reception unit 16 executing the JavaScript® in response to the reception of the response message including the function call.

The method of displaying the confirmation message on the user terminal 10A is not limited to the above-described example. When the response message received by the reception unit 16 includes the parameters to be managed by the application, the user terminal 10A may display the parameters as a confirmation message.

In the user terminal 10A, when the operation reception unit 13 receives an operation to instruct creation of the application at S2316, the instruction generator 14 generates an instruction to create the application for transmission to the information processing system 20 at step S2317. The application creation instruction being generated includes the parameters included in the response message received at step S2314.

The server communication unit 11A of the user terminal 10A transmits the application creation instruction to the information processing system 20 at step S2318. As described above, the user terminal 10A transmits the parameters managed by the application to the information processing system 20, such that the information processing system 20 can create the application based on the parameters.

Since the processes from step S2319 to step S2322 of FIG. 23 are the same as the processes from step S1422 to step S1425 of FIG. 14, the description thereof is omitted.

As described above, according to the present embodiment, the user terminal 10A generates the prompt to be transmitted to the generative AI system 50, thus reducing the processing load on the information processing system 20.

In FIG. 23, the generative AI system 50 may be implemented by the edge AI on the user terminal 10A, such as the AI model dedicated to creation of the application. In such case, the prompts are transmitted to the edge AI of the user terminal 10A at step S2308 and step S2313.

By using the edge AI on the user terminal 10A, the communication load on the network, which may be caused due to transmission of prompts and reception of response messages, can be reduced. With the use of the edge AI on the user terminal 10A, the user terminal 10A does not always have to communicate via the network to display information. For example, the time taken from the input of the message at step S2306 to the display of the response message at step S2310 is reduced. In another example, the time taken from the input of the message at step S2311 to the display of the confirmation message at step S2315 is reduced. This speeds up the overall processes for outputting the result.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The apparatuses or devices described in one or more embodiments are just one example of plural computing environments that implement the one or more embodiments disclosed herein.

In some embodiments, the one or more information processing apparatuses in the information processing system 20 include multiple computing devices, such as a server cluster. The multiple computing devices are configured to communicate with one another through any type of communication link, including a network, a shared memory, etc., to collectively perform the processes disclosed herein. In substantially the same manner, the information processing apparatuses in the information processing system 20 can each include multiple computing devices configured to communicate with one another.

Further, the information processing apparatuses in the information processing system 200 may be configured to share the processing steps disclosed herein in various combinations. For example, a process executed by a predetermined unit may be executed by any number of information processing apparatuses included in the information processing system 20. Similarly, the functions executed by one or more functional units may be performed by any one of the computing devices each operating as the information processing apparatus in the information processing system 20. The functional elements of the information processing apparatus in the information processing system 20 may be integrated into one server apparatus or may be divided into a plurality of apparatuses.

The one or more information processing apparatuses, which operate as the information processing system 200, may be any apparatus having a communication function. Other examples of the information processing system 20 include, but not limited to, an output device such as a Projector (PJ), an Interactive White Board (a white board having an electronic whiteboard function capable of mutual communication (IWB)), and a digital signage, a Head Up Display (HUD) device, an industrial machine, an imaging device, a sound collecting device, a medical device, a network home appliance, an automobile (connected car), a notebook Personal Computer (PC), a mobile phone, a smartphone, a tablet terminal, a game console, a Personal Digital Assistant (PDA), a digital camera, a wearable PC or a desktop PC.

### Aspects

### Aspect 1

An information processing apparatus communicably connected with a terminal apparatus and a generative artificial intelligence (AI) system via a network, includes a display controller, a chat message reception unit, a first transmission unit, a first reception unit, and an application creator. The display controller causes the terminal apparatus to display an application creation screen that receives a user operation to arrange a plurality of components for an application to be created, the application creation screen including a button for receiving a request for assistance by the AI in creating the application. The chat message reception unit receives, from the terminal apparatus, a chat message input on a chat screen for receiving the assistance by the AI, the chat screen being displayed on the terminal apparatus in response to reception of an operation on the button included in the application creation screen displayed on the terminal apparatus. The first transmission unit transmits, to the generative AI system, the received chat message and an instruction to generate parameters related to creation of the application based on the received chat message. The first reception unit receives a request generated by the generative AI system based on the instruction, the request including the parameters related to creation of the application. The application creator creates the application based on the received parameters. The display controller updates the application creation screen so as to display the plurality of components of the created application on the application creation screen.

### Aspect 2

In the information processing apparatus of Aspect 1, the application creator is implemented with execution of a function that is preset. The first transmission unit transmits a function name identifying the function to the generative AI system at least once. The first reception unit receives the request generated by the generative AI system, the request including the function name. The application creator is implemented with execution of the function identified with the function name included in the request that is received.

### Aspect 3

In the information processing apparatus of Aspect 1 or Aspect 2, the display controller transmits, to the terminal apparatus, information for identifying each of the plurality of components of the created application and information indicating the arrangement of each of the plurality of components, to update the application creation screen.

### Aspect 4

In the information processing apparatus of any one of Aspect 1 to Aspect 3, in the case where the plurality of components are arranged on the application creation screen, the first transmission unit transmits, to the generative AI system, the received chat message and the instruction to generate the parameters related to creation of the application based on the received chat message. The parameters includes information indicating the arrangement of each of the plurality of components, and information for identifying each of the plurality of components. The first reception unit receives a request generated by the generative AI system based on the instruction. The request includes the parameters including the information indicating the arrangement of each of the plurality of components and the information for identifying each of the plurality of components. The application creator creates the application based on the parameters including the information indicating the arrangement of each of the plurality of components and the information for identifying each of the plurality of components.

### Aspect 5

In the information processing apparatus of to any one of Aspect 1 to Aspect 4, in the case where an operation for instructing to create the application using the plurality of components on the application creation screen is performed on the terminal apparatus, the first transmission unit transmits, to the generative AI system, the instruction to generate the parameters related to creation of the application based on the received chat message. The parameters includes information indicating the arrangement of each of the plurality of components, and information for identifying each of the plurality of components.

### Aspect 6

In the information processing apparatus of any one of Aspect 1 to Aspect 5, in response to receiving operation on the button on the application creation screen, the chat screen is displayed on the terminal apparatus in a pop-up window.

### Aspect 7

In the information processing apparatus of any one of Aspect 1 to Aspect 6, the chat screen is displayed on a display for the terminal apparatus with the application creation screen.

### Aspect 8

An application creation system includes a terminal apparatus, a generative artificial intelligence (AI) system, and an information processing apparatus, which are communicably connected with one another via a network. The information processing apparatus includes a display controller, a chat message reception unit, a first transmission unit, a first reception unit, and an application creator. The display controller causes the terminal apparatus to display an application creation screen that receives a user operation to arrange a plurality of components for an application to be created, the application creation screen including a button for receiving a request for assistance by the AI in creating the application. The chat message reception unit receives, from the terminal apparatus, a chat message input on a chat screen for receiving the assistance by the AI, the chat screen being displayed on the terminal apparatus in response to reception of an operation on the button included in the application creation screen displayed on the terminal apparatus. The first transmission unit transmits, to the generative AI system, the received chat message and an instruction to generate parameters related to creation of the application based on the received chat message. The first reception unit receives a request generated by the generative AI system based on the instruction, the request including the parameters related to creation of the application. The application creator creates the application based on the received parameters. The display controller updates the application creation screen so as to display the plurality of components of the created application on the application creation screen.

### Aspect 9

A program causes an information processing apparatus, which is communicably connected with a terminal apparatus and a generative artificial intelligence (AI) system via a network, to function as a display controller, a chat message reception unit, a first transmission unit, a first reception unit, and an application creator. The display controller causes the terminal apparatus to display an application creation screen that receives a user operation to arrange a plurality of components for an application to be created, the application creation screen including a button for receiving a request for assistance by the AI in creating the application. The chat message reception unit receives, from the terminal apparatus, a chat message input on a chat screen for receiving the assistance by the AI, the chat screen being displayed on the terminal apparatus in response to reception of an operation on the button included in the application creation screen displayed on the terminal apparatus. The first transmission unit transmits, to the generative AI system, the received chat message and an instruction to generate parameters related to creation of the application based on the received chat message. The first reception unit receives a request generated by the generative AI system based on the instruction, the request including the parameters related to creation of the application. The application creator creates the application based on the received parameters. The display controller updates the application creation screen so as to display the plurality of components of the created application on the application creation screen.

### Aspect 10

An information processing apparatus communicably connected with a terminal apparatus and a generative artificial intelligence (AI) system via a network, performs an application creation method. The application creation method includes: displaying, at the terminal apparatus, an application creation screen that receives a user operation to arrange a plurality of components for an application to be created, the application creation screen including a button for receiving a request for assistance by the AI in creating the application; receiving, from the terminal apparatus, a chat message input on a chat screen for receiving the assistance by the AI, the chat screen being displayed on the terminal apparatus in response to reception of an operation on the button included in the application creation screen displayed on the terminal apparatus; transmitting, to the generative AI system, the received chat message and an instruction to generate parameters related to creation of the application based on the received chat message; receiving a request generated by the generative AI system based on the instruction, the request including the parameters related to creation of the application; creating the application based on the received parameter; and updating the application creation screen so as to display the plurality of components of the created application on the application creation screen.

### Aspect 11

An application creation system includes a terminal apparatus and an information processing apparatus that are communicably connected via a network. The terminal apparatus includes a server communication unit, a display controller, a first transmission unit, and a first reception unit.

The server communication unit acquires, from the information processing apparatus, web content data for displaying an application creation screen. The application creation screen receives a user operation to arrange a plurality of components for an application to be created, and includes a button for receiving a request for assistance by the AI in creating the application. The display controller causes a display unit to display the application creation screen based on the acquired web content data. The first transmission unit transmits, to the generative AI system via the network, a chat message input on a chat screen for receiving the assistance by the AI, and an instruction to generate parameters related to the creation of the application based on the received chat message, the chat screen being displayed on the terminal apparatus in response to reception of an operation on the button included in the application creation screen displayed on the terminal apparatus. The first reception unit receives a request generated by the generative AI system based on the instruction, the request including the parameters related to creation of the application. The server communication unit transmits the received parameters to the information processing apparatus, and receives update information for displaying, on the application creation screen, a plurality of components of the created application having been created by the information processing apparatus based on the parameters. The display controller displays the plurality of components of the created application on the application creation screen based on the received update information.

The information processing apparatus includes: a second transmission unit configured to transmit the web content to the terminal apparatus; an application creator configured to create the application based on the parameters transmitted from the terminal apparatus; and a third transmission unit configured to transmit, to the terminal apparatus, the update information for displaying the plurality of components of the created application on the application creation screen.

### Aspect 12

In the application creation system of Aspect 11, the terminal apparatus includes an instruction generator that generates the instruction. The server communication unit receives, from the information processing apparatus, a program for executing generation of the instruction and transmission of the generated instruction to the generative AI system. The instruction generator executes the received program to generate the instruction. The first transmission unit executes the received program to transmit the instruction to the generative AI system.

### Aspect 13

In the application creation system of Aspect 11 or Aspect 12, the server communication unit receives screen information of the application creation screen from the information processing apparatus, the screen information including the program. The display controller causes the display unit to display the application creation screen based on the received screen information.

### Aspect 14

In the application creation system of Aspect 13, the screen information is data described in HTML, and the program is a program described in JavaScript®.

### Aspect 15

An application creation system includes a terminal apparatus and an information processing apparatus communicably connected via a network performs an application creation method. The terminal apparatus performs a method including: acquiring, from the information processing apparatus, web content data for displaying an application creation screen. The application creation screen receives a user operation to arrange a plurality of components for an application to be created, and includes a button for receiving a request for assistance by the AI in creating the application. The method further including: displaying, on a display unit, the application creation screen based on the acquired web content data; transmitting, to the generative AI system via the network, a chat message input on a chat screen for receiving the assistance by the AI, and an instruction to generate parameters related to the creation of the application based on the received chat message, the chat screen being displayed on the terminal apparatus in response to reception of an operation on the button included in the application creation screen displayed on the terminal apparatus; receiving a request generated by the generative AI system based on the instruction, the request including the parameters related to creation of the application; transmitting the received parameters to the information processing apparatus; receiving update information for displaying, on the application creation screen, a plurality of components of the created application having been created by the information processing apparatus based on the parameters; and displaying the plurality of components of the created application on the application creation screen based on the received update information. The information processing apparatus performs a method including transmitting the web content to the terminal apparatus; creating the application based on the parameters transmitted from the terminal apparatus; and transmitting, to the terminal apparatus, the update information for displaying the plurality of components of the created application on the application creation screen.

1. An information processing apparatus communicably connected with a terminal apparatus and a generative artificial intelligence (AI) system via a network, the information processing apparatus comprising circuitry configured to:
cause the terminal apparatus to display an application creation screen that receives a user operation to arrange a plurality of components for an application to be created, the application creation screen including a button for receiving a request for assistance by the AI in creating the application;
cause the terminal apparatus to display a chat screen for receiving the assistance by the AI in response to reception of an operation on the button in the application creation screen;
receive, from the terminal apparatus, a chat message input on the chat screen;
transmit, to the generative AI system, the received chat message and an instruction to generate parameters related to creation of the application based on the received chat message;
receive a request generated by the generative AI system based on the instruction, the request including the parameters related to creation of the application;
create the application based on the received parameters; and
cause the terminal apparatus to display an updated application creation screen including the plurality of components of the created application.

2. The information processing apparatus according to claim 1, wherein the circuitry is configured to:
transmit a function name identifying a preset function to the generative AI system at least once;
receive the request generated by the generative AI system, the request including the function name; and
execute the preset function identified with the function name included in the received request to create the application.

3. The information processing apparatus according to claim 1, wherein the circuitry is configured to
transmit, to the terminal apparatus, identification information for identifying each of the plurality of components of the created application and arrangement information indicating arrangement of each of the plurality of components of the created application, the application creation screen being updated based on the identification information and the arrangement information.

4. The information processing apparatus according to claim 1, wherein
in a case where the plurality of components are arranged on the application creation screen, the circuitry is configured to:
transmit, to the generative AI system, the received chat message, and the instruction to generate the parameters related to creation of the application based on the received chat message, the parameters including identification information for identifying each of the plurality of components and arrangement information indicating arrangement of each of the plurality of components;
receive a request generated by the generative AI system based on the instruction, the request including the parameters including the identification information and the arrangement information; and
create the application based on the parameters including the identification information and the arrangement information.

5. The information processing apparatus according to claim 4,
wherein, in a case where an operation for instructing creation of the application using the plurality of components arranged on the application creation screen is performed on the terminal apparatus,
the circuitry is configured to transmit, to the generative AI system, the instruction to generate the parameters related to creation of the application based on the received chat message, the parameters including the identification information and the arrangement information of each of the plurality of components.

6. The information processing apparatus according to claim 1, wherein, in response to receiving a user operation on the button in the application creation screen, the chat screen is displayed on the terminal apparatus in a pop-up window.

7. The information processing apparatus according to claim 1, wherein the chat screen is displayed on a display of the terminal apparatus with the application creation screen.

8. An application creation method comprising:
displaying, on a display, an application creation screen that receives a user operation to arrange a plurality of components for an application to be created, the application creation screen including a button for receiving a request for assistance by an artificial intelligence (AI) in creating the application;
displaying, on the display, a chat screen for receiving the assistance by the AI in response to reception of an operation on the button in the application creation screen;
receiving a chat message input on the chat screen;
transmitting, to a generative AI system, the received chat message and an instruction to generate parameters related to creation of the application based on the received chat message;
receiving a request generated by the generative AI system based on the instruction, the request including the parameters related to creation of the application;
creating the application based on the received parameters; and
displaying, on the display, an updated application creation screen including the plurality of components of the created application.

9. An application creation system comprising:
a terminal apparatus comprising terminal circuitry; and
an information processing apparatus communicably connected with the terminal apparatus via a network, the information processing apparatus comprising apparatus circuitry,
the terminal circuitry being configured to:
acquire, from the information processing apparatus, web content data for displaying an application creation screen that receives a user operation to arrange a plurality of components for an application to be created, the application creation screen including a button for receiving a request for assistance by an artificial intelligence (AI) in creating the application;
display, on a display, the application creation screen based on the acquired web content data;
transmit, to a generative AI system via the network, a chat message input on a chat screen for receiving the assistance by the AI, and an instruction to generate parameters related to creation of the application based on the received chat message, the chat screen being displayed on the display in response to reception of an operation on the button in the application creation screen;
receive a request generated by the generative AI system based on the instruction, the request including the parameters related to creation of the application;
transmit the received parameters to the information processing apparatus;
receive update information for displaying, on the application creation screen, a plurality of components of the created application having been created by the information processing apparatus based on the parameters; and
display the plurality of components of the created application on the application creation screen based on the received update information,
the apparatus circuitry being configured to:
transmit the web content to the terminal apparatus;
create the application based on the parameters transmitted from the terminal apparatus; and
transmit, to the terminal apparatus, the update information for causing the application creation screen to display the plurality of components of the created application.
